(19) United States
(12) Patent Application Publication
(10) Pub. No.: US 2021/0082211 A1
(43) Pub. Date: Mar. 18, 2021

(54) SYSTEMS AND METHODS FOR MANAGING AN ITEM

(71) Applicant: BEIJING DIDI INFINITY TECHNOLOGY AND DEVELOPMENT CO., LTD., Beijing (CN)

(72) Inventors: Hongjing SUN, Beijing (CN); Xinwen ZHONG, Beijing (CN); Le YAN, Beijing (CN); Limin ZHANG, Beijing (CN); Zhenzi LIU, Beijing (CN)

(73) Assignee: BEIJING DIDI INFINITY TECHNOLOGY AND DEVELOPMENT CO., LTD., Beijing (CN)

(21) Appl. No.: 17/103,967

(22) Filed: Nov. 25, 2020

Related U.S. Application Data
(63) Continuation of application No. PCT/CN2019/070332, filed on Jan. 4, 2019.

(30) Foreign Application Priority Data
Jun. 1, 2018 (CN) 201810559368.X
Jun. 1, 2018 (CN) 201810559370.7

(51) Int. Cl. G07C 5/00; H04W 4/40; H04W 12/0431

(52) U.S. Cl. CPC G07C 5/008; H04W 12/0431; H04W 4/40

(57) ABSTRACT

A method is provided to manage an item connected to an Internet of Things (IoT) platform via an object. The method may include receiving, on the IoT platform, a request for an action relating to the item from a user terminal. The method may include generating a first instruction for processing the action relating to the item in response to the request. The method may include providing, from the IoT platform, the first instruction to the object and/or the user terminal. The method may include receiving, on the IoT platform, feedback information regarding the item upon completion of the action relating to the item in accordance with the first instruction. The method may further include generating, based on the feedback information, a second instruction for triggering, based on the completion of the action, an operation mode of the object.

### CROSS-REFERENCE TO RELATED APPLICATIONS

This application is a continuation of International Patent Application No. PCT/CN2019/070332, filed on Jan. 4, 2019, which claims priority of Chinese Patent Application No. 201810559370.7 filed on Jun. 1, 2018, and Chinese Patent Application No. 201810559368.X filed on Jun. 1, 2018, the entire contents of each of which are hereby incorporated by reference.

### TECHNICAL FIELD

This disclosure generally relates to information and communication technologies, and in particular, relates to systems and methods for managing an item connected to an Internet of Things (IoT) platform, for example, controlling a vehicle by a vehicle management platform configured to achieve at least a partial control of the vehicle remotely.

### BACKGROUND

Internet of Things (IoT) is a network that connects various devices, for example, vehicles, user terminals, and/or home appliances, that contain electronics, software, actuators, and connectivity which allows these things to connect, interact and exchange data. For example, a user may manage an item (e.g., checking out the item to utilize) by interacting with the IoT platform to which the item is connected. On the one hand, it is necessary that the items are always connected to the IoT platform via one or more networks to allow the IoT platform to control or monitor the items. The items need to consume energy (e.g., electrical energy) to remain connected with the IoT platform. Once the electrical energy is used up, the items may loss contact with the IoT platform, and then the items may be not managed by the IoT platform timely and effectively. Moreover, the IoT platform may need to control the items remotely, e.g., causing the items to change modes, e.g., from locked to unlocked. The IoT platform needs to provide secure solutions for controlling the items connected thereto. Therefore, it is desirable to develop systems and methods for managing items connected to an IoT platform effectively and safely.

### SUMMARY

According to one aspect of the present disclosure, a method is provided to manage an item connected to an Internet of Things (IoT) platform via an object. The IoT platform is configured to provide shared use of the item. The method may include one or more of the following operations. At least one processor may receive a request for an action relating to the item from a user terminal on the IoT platform. The at least one processor may generate a first instruction for processing the action relating to the item in response to the request. The at least one processor may provide, from the IoT platform, the first instruction to the object and/or the user terminal. The at least one processor may receive, on the IoT platform, feedback information regarding the item upon completion of the action relating to the item in accordance with the first instruction. The at least one processor may generate, based on the feedback information, a second instruction for triggering, based on the completion of the action, an operation mode of the object.

In some embodiments, the action relating to the item may include at least one of returning the item, locking the item, checking out the item, or unlocking the item.

In some embodiments, the operation mode of the object includes at least one of an energy-saving mode, a sleeping mode, or a working mode.

In some embodiments, the second instruction may further include a secret key. The at least one processor may transmit, from the IoT platform, the secret key to the object.

In some embodiments, the at least one processor may receive a second request for a second action relating to the item from a second user terminal. In response to the second request, the at least one processor may generate a third instruction for changing the object from the operation mode to a second operation mode.

In some embodiments, the third instruction further may further include a second secret key. The at least one processor may transmit, from the IoT platform, the second secret key to the second user terminal and/or the object.

In some embodiments, at least one of the secret key or the second secret key may include a Bluetooth pairing code or a message verification code.

In some embodiments, the at least one processor may determine, based on a relationship of the secret key and the second secret key, whether to change the object from the operation mode to the second operation mode.

In some embodiments, the operation mode may be an energy-saving mode, the second operation mode may be a working mode. The at least one processor may perform a matching operation between the secret key and the second secret key, and trigger the object from the energy-saving mode to the working mode in response to a match between the secret key and the second secret key.

In some embodiments, the second instruction may further include an instruction for locking the item and a third secret key, and the third instruction may further include an instruction for unlocking the item and a fourth secret key. The at least one processor may perform a matching operation between the third secret key and the fourth secret key, and unlock the item in response to a match between the third secret key and the fourth secret key.

In some embodiments, at least one of the third secret key or the fourth secret key may include a Bluetooth pairing code or a message verification code.

According to another aspect of the present disclosure, a system is provided to manage an item connected to an Internet of Things (IoT) platform via an object. The IoT platform is configured to provide shared use of the item. The system may include at least one storage device, at least one processor in communication with the at least one storage device. The at least one storage device may include one or more sets of instructions. When executing the one or more sets of instructions, the at least one processor may receive a request for an action relating to the item from a user terminal on the IoT platform. The at least one processor may generate a first instruction for processing the action relating to the item in response to the request. The at least one processor may provide, from the IoT platform, the first instruction to the object and/or the user terminal. The at least one processor may receive, on the IoT platform, feedback information regarding the item upon completion of the action relating to the item in accordance with the first instruction. The at least one processor may generate, based on the feedback information, a second instruction for triggering, based on the completion of the action, an operation mode of the object.

According to another aspect of the present disclosure, a non-transitory computer readable medium is provided to manage an item connected to an Internet of Things (IoT) platform via an object. The IoT platform is configured to provide shared use of the item. The non-transitory computer readable medium may comprise executable instructions that cause at least one processor to effectuate a method. The method may include one or more of the following operations. At least one processor may receive a request for an action relating to the item from a user terminal on the IoT platform. The at least one processor may generate a first instruction for processing the action relating to the item in response to the request. The at least one processor may provide, from the IoT platform, the first instruction to the object and/or the user terminal. The at least one processor may receive, on the IoT platform, feedback information regarding the item upon completion of the action relating to the item in accordance with the first instruction. The at least one processor may generate, based on the feedback information, a second instruction for triggering, based on the completion of the action, an operation mode of the object.

According to another aspect of the present disclosure, a method is provided to control a telematics box (Tbox) of a vehicle. The Tbox of the vehicle may be connected to a vehicle management platform configured to provide shared use of the vehicle. The method may include one or more of the following operations. At least one processor may receive, on the vehicle management platform and from a user terminal, a request for an action of returning the vehicle, the request including an identifier of the Tbox of the vehicle. The at least one processor may generate a first instruction for processing the action of returning the vehicle in response to the request. The at least one processor may provide, from the vehicle management platform, the first instruction to the Tbox of the vehicle. The at least one processor may receive, on the vehicle management platform, feedback information regarding the vehicle upon completion of the action of the returning the vehicle in accordance with the first instruction. The at least one processor may generate, based on the feedback information, a second instruction for triggering a mode change of the Tbox from a working mode to a sleeping mode.

In some embodiments, the second instruction may further include a secret key. The at least one processor may transmitting, from the vehicle management platform, the secret key to the Tbox of the vehicle.

In some embodiments, the at least one processor may receive, on the vehicle management platform and from a second user terminal, a second request for a second action of checking out the vehicle. The second request may include the identifier of the Tbox of the vehicle. In response to the second request, the at least one processor may generate, a third instruction for changing the Tbox from the sleeping mode to the working mode. The third instruction may include a second secret key. The processor may transmit, from the vehicle management platform and to the second user terminal, the second secret key.

In some embodiments, the at least one processor may perform a matching operation between the secret key and the second secret key, and trigger the mode change of the Tbox from the sleeping mode to the working mode in response to a match between the secret key and the second secret key.

In some embodiments, the third instruction may further include a message verification code. The at least one processor may transmit, from the vehicle management platform, the message verification code directly to the Tbox for triggering the mode change of the Tbox from the sleeping mode to the working mode.

According to another aspect of the present disclosure, a system is provided to control a telematics box (Tbox) of a vehicle. The Tbox of the vehicle may be connected to a vehicle management platform configured to provide shared use of the vehicle. The system may include at least one storage device, at least one processor in communication with the at least one storage device. The at least one storage device may include one or more sets of instructions. When executing the one or more sets of instructions, the at least one processor may receive, on the vehicle management platform and from a user terminal, a request for an action of returning the vehicle, the request including an identifier of the Tbox of the vehicle. The at least one processor may generate a first instruction for processing the action of returning the vehicle in response to the request. The at least one processor may provide, from the vehicle management platform, the first instruction to the Tbox of the vehicle. The at least one processor may receive, on the vehicle management platform, feedback information regarding the vehicle upon completion of the action of the returning the vehicle in accordance with the first instruction. The at least one processor may generate, based on the feedback information, a second instruction for triggering a mode change of the Tbox from a working mode to a sleeping mode.

According to another aspect of the present disclosure, a non-transitory computer readable medium is provided to control a telematics box (Tbox) of a vehicle. The Tbox of the vehicle may be connected to a vehicle management platform configured to provide shared use of the vehicle. The non-transitory computer readable medium may comprise executable instructions that cause at least one processor to effectuate a method. The method may include one or more of the following operations. At least one processor may receive, on the vehicle management platform and from a user terminal, a request for an action of returning the vehicle, the request including an identifier of the Tbox of the vehicle. The at least one processor may generate a first instruction for processing the action of returning the vehicle in response to the request. The at least one processor may provide, from the vehicle management platform, the first instruction to the Tbox of the vehicle. The at least one processor may receive, on the vehicle management platform, feedback information regarding the vehicle upon completion of the action of the returning the vehicle in accordance with the first instruction. The at least one processor may generate, based on the feedback information, a second instruction for triggering a mode change of the Tbox from a working mode to a sleeping mode.

According to another aspect of the present disclosure, a method is provided to control a telematics box (Tbox) of a vehicle. The Tbox of the vehicle may be connected to a vehicle management platform configured to provide shared use of the vehicle. The method may include one or more of the following operations. At least one processor may receive, on the Tbox, a first instruction for processing an action of returning the vehicle from the vehicle management platform. The at least one processor may perform, on the Tbox, the action of returning of the vehicle in response to the first instruction. The at least one processor may transmit, from the Tbox, feedback information regarding the vehicle to the vehicle management platform upon completion of the action of returning the vehicle. The at least one processor may receive, on the Tbox and from the vehicle management platform, a second instruction for triggering a mode change of the Tbox from a working mode to a sleeping mode. The second instruction may be generated by the vehicle management platform according to the feedback information.

In some embodiments, the second instruction may further include a secret key. The at least one processor may receive, on the Tbox and from the vehicle management platform, the secret key. The at least one processor may store, on the Tbox, the secret key in a non-transitory computer readable medium.

In some embodiments, the at least one processor may receive, on the Tbox and from a second user terminal, a second secret key. The second secret key may be part of a third instruction generated by the vehicle management platform when the vehicle management platform receives a request for checking out the vehicle associated with the Tbox, and the second secret key may be transmitted from the vehicle management platform to the second user terminal. The at least one processor may perform a matching operation between the secret key and the second secret key. The at least one processor may trigger a mode change of the Tbox from the sleeping mode to the working mode in response to a match between the secret key and the second secret key.

In some embodiments, the at least one processor may receive, on the Tbox and from the vehicle management platform, a message verification code. The at least one processor may verify, on the Tbox, the message verification code. The at least one processor may trigger a mode change of the Tbox from the sleeping mode to the working mode in response to a successful verification.

In some embodiments, the at least one processor may detect, on the Tbox, a vibration status of the vehicle, and trigger the mode change of the Tbox from the sleeping mode to the working mode based on the detected vibration state of the vehicle.

In some embodiments, the at least one processor may report, to the vehicle management platform, the detected vibration status of the vehicle.

According to another aspect of the present disclosure, a system is provided to control a telematics box (Tbox) of a vehicle. The Tbox of the vehicle may be connected to a vehicle management platform configured to provide shared use of the vehicle. The system may include at least one storage device, at least one processor in communication with the at least one storage device. The at least one storage device may include one or more sets of instructions. When executing the one or more sets of instructions, the at least one processor may receive, on the Tbox, a first instruction for processing an action of returning the vehicle from the vehicle management platform. Tha at least one processor may perform, on the Tbox, the action of returning of the vehicle in response to the first instruction. The at least one processor may transmit, from the Tbox, feedback information regarding the vehicle to the vehicle management platform upon completion of the action of returning the vehicle. The at least one processor may receive, on the Tbox and from the vehicle management platform, a second instruction for triggering a mode change of the Tbox from a working mode to a sleeping mode. The second instruction may be generated by the vehicle management platform according to the feedback information.

According to another aspect of the present disclosure, a non-transitory computer readable medium is provided to control a telematics box (Tbox) of a vehicle. The Tbox of the vehicle may be connected to a vehicle management platform configured to provide shared use of the vehicle. The non-transitory computer readable medium may comprise executable instructions that cause at least one processor to effectuate a method. The method may include one or more of the following operations. At least one processor may receive, on the Tbox, a first instruction for processing an action of returning the vehicle from the vehicle management platform. Tha at least one processor may perform, on the Tbox, the action of returning of the vehicle in response to the first instruction. The at least one processor may transmit, from the Tbox, feedback information regarding the vehicle to the vehicle management platform upon completion of the action of returning the vehicle. The at least one processor may receive, on the Tbox and from the vehicle management platform, a second instruction for triggering a mode change of the Tbox from a working mode to a sleeping mode. The second instruction may be generated by the vehicle management platform according to the feedback information.

According to another aspect of the present disclosure, a method is provided to unlock a vehicle. The vehicle configured with a telematics box (Tbox) may be connected to a vehicle management platform configured to provide shared use of the vehicle. The method may include one or more of the following operations. At least one processor may receive, on the vehicle management platform and from a user terminal, a request for an action of returning the vehicle, the request including an identifier of the Tbox of the vehicle. The at least one processor may generate a secret key upon receipt of the request. The at least one processor may provide, from the vehicle management platform, an instruction including the secret key to the Tbox, the secret key being configured to unlock the vehicle.

In some embodiments, the at least one processor may receive, on the vehicle management platform and from a second user terminal, a second request for an action of unlocking the vehicle, the request including the identifier of the Tbox of the vehicle. In response to the second request, the at least one processor may provide, from the vehicle management platform, a second instruction including a second secret key to the second user terminal. The at least one processor may perform a matching operation between the secret key and the second secret key. The at least one processor may unlock the vehicle in response to a match between the secret key and the second secret key.

In some embodiments, the at least one processor may receive, on the vehicle management platform and from the second user terminal or from the vehicle, information indicating that the vehicle fails to unlock. In response to the received information indicating that the vehicle fails to unlock, the at least one processor may provide, from the vehicle management platform to the Tbox, a third instruction for resetting the secret key.

In some embodiments, the at least one processor may receive, on the vehicle management platform, information indicating a successful reset of the secret key of the Tbox. In response to the information indicating the successful reset of the secret key of the Tbox, the at least one processor may generate, via the vehicle management platform, a fourth instruction to the second user terminal for prompting to retry to unlock the vehicle.

According to another aspect of the present disclosure, a system is provided to unlock a vehicle. The vehicle configured with a telematics box (Tbox) may be connected to a vehicle management platform configured to provide shared use of the vehicle. The system may include at least one storage device, at least one processor in communication with the at least one storage device. The at least one storage device may include one or more sets of instructions. When executing the one or more sets of instructions, the at least one processor may receive, on the vehicle management platform and from a user terminal, a request for an action of returning the vehicle, the request including an identifier of the Tbox of the vehicle. The at least one processor may generate a secret key upon receipt of the request. The at least one processor may provide, from the vehicle management platform, an instruction including the secret key to the Tbox, the secret key being configured to unlock the vehicle.

According to another aspect of the present disclosure, a non-transitory computer readable medium is provided to unlock a vehicle. The vehicle configured with a telematics box (Tbox) may be connected to a vehicle management platform configured to provide shared use of the vehicle. The non-transitory computer readable medium may comprise executable instructions that cause at least one processor to effectuate a method. The method may include one or more of the following operations. At least one processor may receive, on the vehicle management platform and from a user terminal, a request for an action of returning the vehicle, the request including an identifier of the Tbox of the vehicle. The at least one processor may generate a secret key upon receipt of the request. The at least one processor may provide, from the vehicle management platform, an instruction including the secret key to the Tbox, the secret key being configured to unlock the vehicle.

According to another aspect of the present disclosure, a method is provided to unlock a vehicle. The vehicle configured with a telematics box (Tbox) may be connected to a vehicle management platform configured to provide shared use of the vehicle. The method may include one or more of the following operations. At least one processor may receive, on the Tbox, an instruction from the vehicle management platform, wherein the instruction includes a secret key configured to unlock the vehicle. The at least one processor may reset the secret key as a target secret key of the Tbox based on the instruction.

In some embodiments, the at least one processor may receive, on the Tbox, a second secret key from a second user terminal. The second secret key may be part of a second instruction generated by the vehicle management platform when the vehicle management platform receives a request for an action of unlocking the vehicle from the second user terminal, and the second secret key may be transmitted from the vehicle management platform to the second user terminal. The at least one processor may perform a matching operation between the secret key and the second secret key, and unlock the vehicle in response to a match between the secret key and the second secret key.

In some embodiments, the at least one processor may receive, on the Tbox and from the vehicle management platform, a third instruction for resetting the secret key. The at least one processor may reset the secret key of the Tbox in response to the third instruction, and transmit, from the Tbox to the vehicle management platform, information indicating a successful reset of the secret key of the Tbox.

According to another aspect of the present disclosure, a system is provided to unlock a vehicle. The vehicle configured with a telematics box (Tbox) may be connected to a vehicle management platform configured to provide shared use of the vehicle. The system may include at least one storage device, at least one processor in communication with the at least one storage device. The at least one storage device may include one or more sets of instructions. When executing the one or more sets of instructions, the at least one processor may receive, on the Tbox, an instruction from the vehicle management platform, wherein the instruction includes a secret key configured to unlock the vehicle. The at least one processor may reset the secret key as a target secret key of the Tbox based on the instruction.

According to another aspect of the present disclosure, a non-transitory computer readable medium is provided to unlock a vehicle. The vehicle configured with a telematics box (Tbox) may be connected to a vehicle management platform configured to provide shared use of the vehicle. The non-transitory computer readable medium may comprise executable instructions that cause at least one processor to effectuate a method. The method may include one or more of the following operations. At least one processor may receive, on the Tbox, an instruction from the vehicle management platform, wherein the instruction includes a secret key configured to unlock the vehicle. The at least one processor may reset the secret key as a target secret key of the Tbox based on the instruction.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary Internet of Things (IoT) system according to some embodiments of the present disclosure;

FIG. 2 is a schematic diagram illustrating exemplary components of a computing device on which an IoT platform may be implemented according to some embodiments of the present disclosure;

FIG. 3 is a schematic diagram illustrating exemplary hardware and/or software components of an exemplary mobile device on which a terminal may be implemented according to some embodiments of the present disclosure;

FIG. 4 is a schematic diagram illustrating exemplary components of a computing device on which an object may be implemented according to some embodiments of the present disclosure;

FIG. 5 is a block diagram illustrating an exemplary processing device on which an IoT platform may be implemented according to some embodiments of the present disclosure;

FIG. 6 is a block diagram illustrating an exemplary processing module of the processing device shown in FIG. 5 according to some embodiments of the present disclosure;

FIG. 7 is a block diagram illustrating an exemplary processing device on which an object may be implemented according to some embodiments of the present disclosure;

FIG. 8 is a block diagram illustrating an exemplary processing module of the processing device shown in FIG. 7 according to some embodiments of the present disclosure;

FIG. 9 is a flowchart illustrating an exemplary process for managing an item according to some embodiments of the present disclosure;

FIG. 10 is a flowchart illustrating an exemplary pipeline process for managing an item according to some embodiments of the present disclosure;

FIG. 11 is a flowchart illustrating an exemplary pipeline process for managing an item according to some embodiments of the present disclosure;

FIG. 12 is a flowchart illustrating an exemplary process for controlling a Tbox of a vehicle according to some embodiments of the present disclosure;

FIG. 13 is a flowchart illustrating an exemplary pipeline process for controlling a Tbox of a vehicle according to some embodiments of the present disclosure;

FIG. 14 is a flowchart illustrating an exemplary process for controlling a Tbox of a vehicle according to some embodiments of the present disclosure;

FIG. 15 is a flowchart illustrating an exemplary process for unlocking a vehicle according to some embodiments of the present disclosure;

FIG. 16 is a flowchart illustrating an exemplary process for unlocking a vehicle according to some embodiments of the present disclosure; and

FIG. 17 is a flowchart illustrating an exemplary process for unlocking a vehicle according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure are described primarily in regard to providing shared use of an item (e.g., shared services), it should also be understood that this is for illustration purposes and not intended to be limiting. The system or method of the present disclosure may be applied to any other kind of online to offline (O2O) services in connection with Internet of Things (IoT). For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, an e-bike, a bicycle, or the like, or any combination thereof. The transportation system may also include any transportation system for management and/or distribution, for example, a system for transmitting and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The term “requester,” “service requester,” and “customer” in the present disclosure are used interchangeably to refer to an individual, an entity, or a tool that may request or order a service. Also, the term “provider,” “service provider,” and “merchant” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a service requester, a customer, a provider, a service provider, or the like, or any combination thereof. The service request may be accepted by any one of a service requester, a customer, a provider, or a service provider through a platform (e.g., a vehicle management platform). The service request may be chargeable or free.

The term “Telematics” is a compound word for telecommunications and information science (Informatics) for long-distance communication. It can be defined as a service system built into automobiles, airlines, ships, trains, which provides information through computer systems, Internet technologies, wireless communication technologies, satellite navigation devices, and data exchange technologies. In other words, the vehicle may be connected to the Internet via a wireless network, providing the owner with the information needed for driving and living.

The term “Telematics box” is known as the Tbox of the vehicle, which is used to communicate with the vehicle management platform or mobile applications to display the vehicle information and control the vehicle operations. The Tbox may also refer to a human-car interactive intelligent information terminal. The users can use GPRS (General Packet Radio Service, such as 2G/3G/4G/5G, etc.), Bluetooth, WIFI, and/or other communication ways through a mobile device or a vehicle management platform, to communicate with the vehicle. For example, the user or the vehicle management platform may control the Tbox to carry out vehicle operations, such as safety monitoring, fault diagnosis, remote control, information sharing, vehicle system updating.

The term “vehicle management platform” may refer to a backend system that uses GPRS (General Packet Radio Service, such as 2G/3G/4G/5G, etc.), Bluetooth, or WIFI, and/or another communication mechanism to communicate with the vehicle. For example, the vehicle management platform may control the Tbox to carry out vehicle operations, such as safety monitoring, fault diagnosis, remote control, information sharing, vehicle system updating.

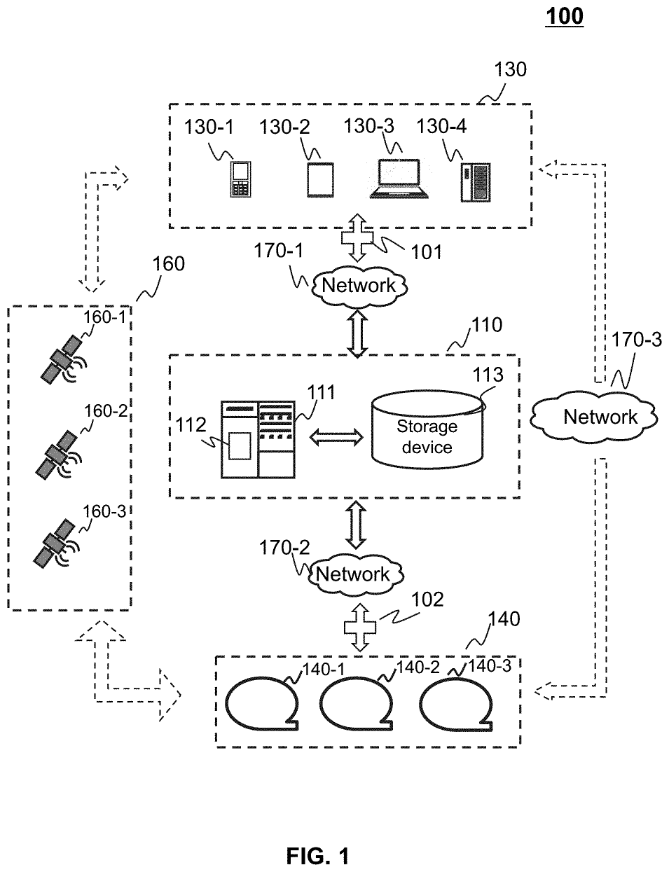

FIG. 1 is a schematic diagram illustrating an exemplary Internet of Things (IoT) system according to some embodiments of the present disclosure. The IoT system 100 may be a platform for data and/or information processing, for example, processing information regarding one or more components included in the IoT system 100. In some embodiments, the IoT system 100 may include a system (e.g., a vehicle management system) for processing a service request associated with a shared used of a vehicle, for example, to perform a checkout action or a returning action. In some embodiments, the service may be a transportation service, such as a car-sharing service, a bicycle-sharing service, etc. In some embodiment, the service may be another online to offline (O2O) service, such as sharing a drone, an aerocar, a wheelchair, a charger, or the like, or any combination thereof.

The IoT system 100 may include an information exchange port system including a first information exchange port 101, a second information exchange port 102, an IoT platform 110, a user terminal system 130, a target item system 140. The IoT platform 110 may include a server 111 and a storage device 113. The user terminal system 130 may include one or more user terminals associated with the service requester(s). The target item system 140 may include one or more items allowable to provide the service in response to the service request. For example, the IoT platform 110 may include a vehicle management platform configured to provide the car-sharing service, the user terminal system 130 may include one or more user terminals associated with users registered in the vehicle management platform, the target item system 140 may include one or more shared vehicles.

In some embodiments, the IoT platform 110 may communicate with one or more user terminals and one or more target items via the first information exchange port 101 and the second information exchange port 102, respectively. For example, the server 111 of the IoT platform 110 may receive information and/or data related to an order request from a mobile device of a service requester via the first information exchange port 101. As another example, the server 111 of the IoT platform 110 may access information and/or data from a controller of a target item (e.g., a Tbox of the vehicle) via the second information exchange port 102. As still another example, the server 111 of the IoT platform 110 may transmit information and/or data to the mobile device of the service requester or the controller of the target item via the information exchange port system. In some embodiments, the information exchange port system (i.e. the first information exchange port 101 and the second information exchange port 102) may be integrated into a single device. In some embodiments, the first information exchange port 101 and the second information exchange port 102 may be separated and be part of different devices. For example, the first information exchange port 101 may be a part of the user terminal system 130, and the second information exchange port 102 may be part of the target item system 140.

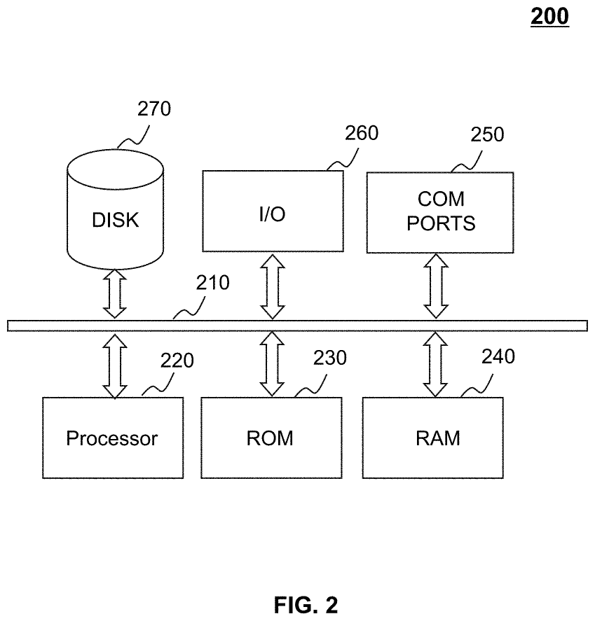

In some embodiments, the server 111 may be a single server, or a server group. The server group may be centralized, or distributed (e.g., the server 111 may be a distributed system). In some embodiments, the server 111 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 111 may be implemented on a computing device having one or more components illustrated in FIG. 2 in the present disclosure.

In some embodiments, the server 111 may include a processing device 112. The processing device 112 may process information and/or data relating to a request to perform one or more functions described in the present disclosure. For example, the processing device 112 may obtain a request from the mobile device 130-1 via the first information exchange port 101, and generate one or more instructions associated with the mobile device 130-1 and/or the target item 140-1 in response to the request. In some embodiments, the processing device 112 may include one or more processors (e.g., single-core processor(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The storage device 113 may store data and/or instructions. In some embodiments, the storage device 113 may store data obtained/acquired from the user terminal system 130 and/or the target item system 140. In some embodiments, the storage device 113 may store data and/or instructions that the server 111 may execute or use to perform exemplary methods and/or processes described in the present disclosure. In some embodiments, the storage device 113 may include a mass storage device, a removable storage device, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 113 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 113 may be connected to or communicate with the server 111. The server 111 may access data or instructions stored in the storage device 113 directly or via a network. In some embodiments, the storage device 113 may be a part of the server 111.

In some embodiments, the user terminal system 130 may include a mobile device 130-1, a tablet computer 130-2, a laptop computer 130-3, a built-in device in a motor vehicle 130-4, or the like, or any combination thereof. The service requester may request a service associated with the target item through the user terminal(s) included in the user terminal system 130. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the user terminal may be a device with positioning technology (e.g., GPS) for locating the position of the requester and/or the user terminal.

In some embodiments, the target item system 140 may include one or more items in connection with the IoT platform 110. For example, the target item system 140 may include a plurality of target devices (or target items) 140-1, 140-2, 140-3. The target devices may be one or more of a vehicle, a bicycle, a drone, or the like, or a combination thereof. As another example, the target item system 140 may include one or more vehicles, one or more bicycles, and/or one or more drones. In some embodiments, the target item may include a controller (e.g., a Tbox of a vehicle, or a processing device of a bicycle) configured to control the item. The controller may communicate with the user terminal system 130 and/or the IoT platform 110. For example, the IoT system 100 may send one or more instructions to the controller for changing an operation mode of the controller. As another example, the user terminal may send one or more instructions to the controller for unlocking the item. In some embodiments, an item may correspond to one type of services (e.g., a car-sharing service, a bicycle-sharing service, or a drone-sharing service, etc.).

A positioning system 160 may determine information associated with an object or a target, for example, one or more user terminals, one or more vehicles. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The positioning system 160 may include one or more satellites, for example, a satellite 160-1, a satellite 160-2, and a satellite 160-3. The satellites 160-1 through 160-3 may determine the information mentioned above independently or jointly. The positioning system 160 may transmit the information mentioned above to the user terminal system 130, the target item system 140 via wireless connections. In some embodiments, the positioning system 160 may transmit the information to the server 111 directly.

Networks 170-1 through 170-3 may facilitate the exchange of information and/or data. In some embodiments, one or more components in the IoT platform 110 (e.g., the server 111 and/or the storage device 113) may transmit and/or receive information and/or data to/from the user terminal system 130 and/or the target item system 140 via the networks 170-1 through 170-3. For example, the server 111 may obtain data relating to a service request via the network 170-1. As another example, the server 111 may obtain availability status of a target item via the network 170-2. In some embodiments, the networks 170-1 through 170-3 may be any type of wired or wireless networks, or combination thereof. Merely by way of example, the networks 170 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof.

FIG. 2 is a schematic diagram illustrating exemplary components of a computing device on which an IoT platform may be implemented according to some embodiments of the present disclosure. As used herein, the IoT platform 110 may be implemented on the computing device 200 illustrated in FIG. 2.

The particular system may use a functional block diagram to explain the hardware platform containing one or more user interfaces. The computing device may be a computer with general or specific functions. Both types of computers may be configured to implement any particular system according to some embodiments of the present disclosure. The computing device 200 may be configured to implement any components that perform one or more functions disclosed in the present disclosure. For example, the ROM 230 and/or RAM 240 may store data and/or instructions that the processor 220 may execute or use to perform exemplary methods and/or processes described in the present disclosure. In some embodiments, the processor 220 may receive a request for an action relating to the item from a user terminal. The processor 220 may generate a first instruction for processing the action in response to the request. The processor 220 may provide the first instruction to an object of the item (e.g., a Tbox of a vehicle) or the user terminal. The processor 220 may obtain feedback information regarding the item upon completion of the action. The processor 220 may generate a second instruction for triggering an operation mode of the object (e.g., the Tbox).

Merely for illustration, in some embodiments, the processor 220 may receive a first request for returning a vehicle to a station connected to a vehicle management platform from a first user terminal. The processor 220 may generate and transmit the first instruction to the Tbox corresponding to an identifier included in the first request. The first instruction may be used to process the returning of the vehicle. In response to the received first instruction, the Tbox may perform the returning of the vehicle, and transmit feedback information regarding the returning of the vehicle. Upon receipt of the feedback information, the processor 220 may generate the second instruction for triggering the Tbox from a working mode to a sleeping mode. In response to the second instruction, the Tbox may be changed from the working mode to the sleeping mode. After finishing the returning of the vehicle, the Tbox may enter the sleeping mode. During the sleeping mode, the vehicle may just open the communication function in order to awaken the Tbox, while other functions may be closed, which may reduce power consumption of the Tbox and prolong the working life of the Tbox.

In some embodiments, when finishing the returning of the vehicle from the first user, the processor 220 may generate at least one secret key corresponding to the Tbox of the vehicle. The processor 220 may provide a secret key reset instruction to the Tbox. The secret key reset instruction includes a first secret key. The Tbox may reset the first secret key as a target secret key of the Tbox. When a second user desires to check out the vehicle from the vehicle management platform, the second user needs to request for the target secret key of the Tbox in order to unlock the vehicle. The target secret key of the Tbox may be dynamically updated, which may improve the safety of the vehicle. In some cases, the target secret key is always generated by Tbox itself, and keeps unchanged. Once a user obtains the target secret key, the user may use the secret key to unlock the vehicle again and again, which cause a great security risk of the vehicle. Therefore the dynamic updated secret key may improve the safety of the vehicle.

The computing device 200 may implement any component of the IoT platform 110 as described herein. In FIGS. 1-2, only one such computer device is shown purely for convenience purposes. One of ordinary skill in the art would understood at the time of filing of this application that the computer functions relating to the service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may transmit out the electronic signals from the processing circuits via the bus 210.

The exemplary computing device may include the internal communication bus 210, program storage and data storage of different forms including, for example, a disk 270, and a read-only memory (ROM) 230, or a random-access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both operation A and operation B, it should be understood that operation A and operation B may also be performed by two different CPUs and/or processors jointly or separately in the computing device 200 (e.g., the first processor executes operation A and the second processor executes operation B, or the first and second processors jointly execute operations A and B).

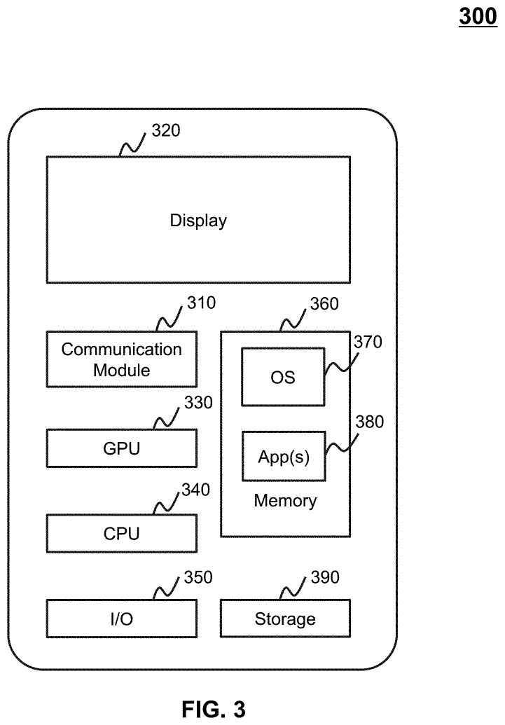

FIG. 3 is a schematic diagram illustrating exemplary hardware and/or software components of an exemplary mobile device on which a terminal may be implemented according to some embodiments of the present disclosure. As used herein, a user terminal of the user terminal system 130 may be implemented on the mobile device 300 according to some embodiments of the present disclosure. As illustrated in FIG. 3, the mobile device 300 may include a communication module 310, a display 320, a graphics processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the IoT platform 110 on the mobile device 300. User interactions with the information stream may be achieved via the I/O devices 350 and provided to the processing device 112 and/or other components of the IoT platform 110 via the network (e.g., the network 170-1, 170-2 or 170-3).

In order to implement various modules, units and their functions described above, a computer hardware platform may be used as hardware platforms of one or more elements (e.g., a component of the server 111 described in FIG. 1). Since these hardware elements, operating systems, and program languages are common, it may be assumed that persons skilled in the art may be familiar with these techniques and they may be able to provide information required in the order request identification according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

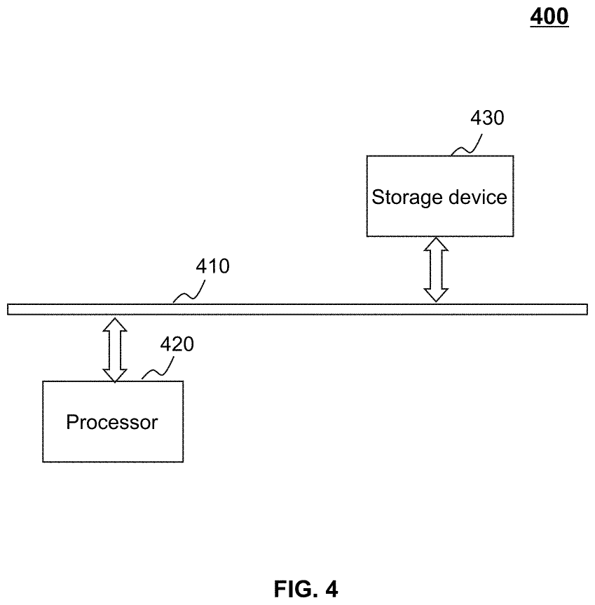

FIG. 4 is a schematic diagram illustrating exemplary components of a computing device on which an object may be implemented according to some embodiments of the present disclosure. For example, a target object of an item of the target item system 140 (e.g., a Tbox of a vehicle of a vehicle management system) may be implemented on the computing device 400 according to some embodiments of the present disclosure. The computing device 400 may at least include a communication bus 410, a processor 420, and a storage device 430. In some embodiments, the processor 420 may communicate with the storage device 430, or external systems or devices (e.g., the user terminal system 130 and the IoT platform 110) through the communication bus 410. In some embodiments, the storage device 430 may store data and/or instructions that the processor 420 may execute or use to perform exemplary methods and/or processes described in the present disclosure.

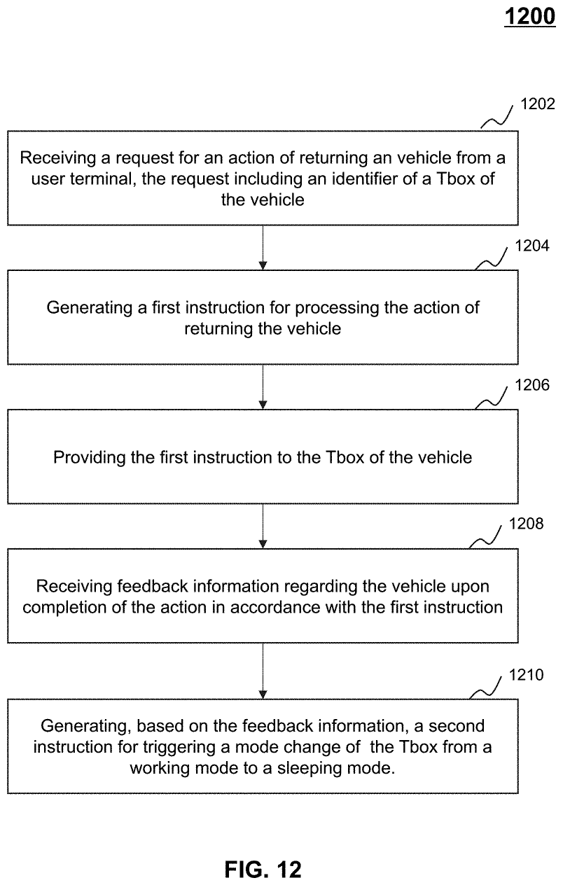

Merely for illustration, in some embodiments, the processor 420 may receive a first instruction for processing an action of returning a vehicle from a vehicle management platform. The processor 420 may perform the action of returning the vehicle in response to the first instruction. The processor 420 may transmit feedback information regarding the vehicle to the vehicle management platform upon completion of the action of returning the vehicle. The processor 420 may receive a second instruction for triggering a mode change of a Tbox of the vehicle, e.g., from a working mode to a sleeping mode. The second instruction may be generated by the vehicle management platform according to the feedback information. More descriptions of triggering a mode change of the Tbox of the vehicle may be found elsewhere in the present disclosure (e.g., FIGS. 12-14, and the descriptions thereof).

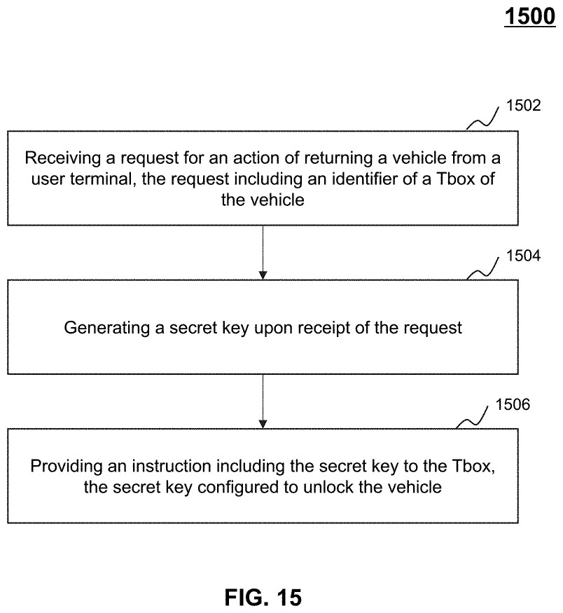

In some embodiments, the processor 420 may receive an instruction from the vehicle management platform. The instruction may include a secret key configured to unlock the vehicle. The processor 420 may reset the received secret key as a target secret key of the Tbox based on the instruction. The processor 420 may perform a match operation between the target secret key and a secret key received from the user terminal. The processor 420 may unlock the vehicle in response to a match result. More descriptions of unlocking the vehicle according to the secret key may be found elsewhere in the present disclosure (e.g., FIGS. 15-17, and the descriptions thereof).

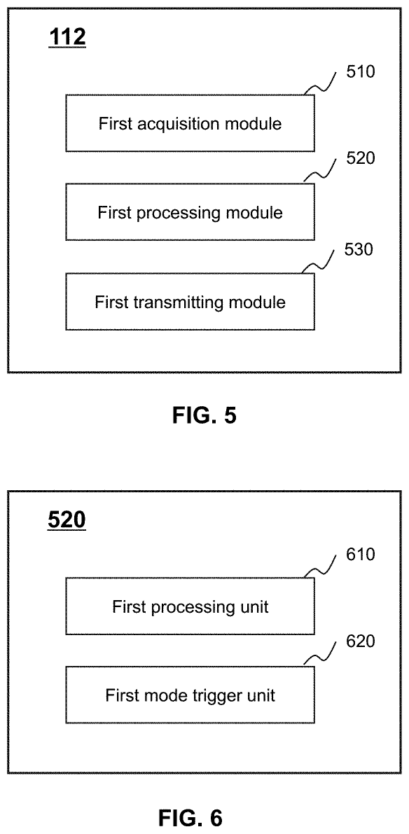

FIG. 5 is a block diagram illustrating an exemplary processing device on which an IoT platform may be implemented according to some embodiments of the present disclosure. The processing device 112 may include a first acquisition module 510, a first processing module 520, and a first transmitting module 530. In some embodiments, the first processing module 520 may further include a first processing unit 610 and a first mode trigger unit 620 as illustrated in FIG. 6. The modules may be hardware circuits of at least part of the processing device 112. The modules may also be implemented as an application or a set of instructions read and executed by the processing device 112. Further, the modules may be any combination of the hardware circuits and the application/instructions. For example, the modules may be the part of the processing device 112 when the processing device 112 is executing the application/set of instructions.

In some embodiments, the first acquisition module 510 may receive a request for an action relating to an item from a user terminal of a service requester. In some embodiments, the item may include a vehicle, a bicycle, a drone, an aerocar, a wheelchair, a charger, or the like, or any combination thereof. The item may be controlled or managed by a target object connected to the IoT platform (e.g., the IoT platform 110). For example, the target object may be a controller built in the item (e.g., a Tbox of a vehicle). In some embodiments, the action relating to the item may include but not limited to returning the item, locking the item, checking out the item, or unlocking the item. Taking a vehicle sharing service as an example, the first acquisition module 510 may receive a request for returning the vehicle to a station connected to a vehicle management platform (e.g., the IoT platform for managing or controlling the vehicle) through a first user terminal of a first service requester after the first service requester finishes using the vehicle. When a second service requester desires to use the vehicle, the first acquisition module 510 may receive a request for checking out the vehicle from the vehicle management platform through a second user terminal of the second service requester. In some embodiments, the first acquisition module 510 may receive a request for locking the vehicle. In some embodiments, the first acquisition module 510 may receive a request for unlocking the vehicle.

In some embodiments, the first processing unit 610 of the processing module 520 may generate an instruction for processing the action. For example, the first processing unit 610 may parse the request, and generate a first instruction for processing the action. In some embodiments, the first instruction may include a secret key resetting instruction for setting or resetting a target secret key of the target object. The secret resetting instruction may include at least one secret key. The secret key may include a Bluetooth pairing code, or a message verification code, or the like, or any combination thereof. For example, the secret resetting instruction includes a first Bluetooth pairing code, the first Bluetooth pairing code may be reset as the target secret key of the Tbox of the vehicle. In some embodiments, the first transmitting module 530 may transmit or provide the generated instruction to the user terminal or the target object of the item. Upon completion of the action, the first acquisition module 510 may receive the feedback information regarding the action. The first acquisition module 510 may further transmit the feedback information to the first mode trigger unit 620, the first mode trigger unit 620 may generate a second instruction for trigger an operation mode of the target object based on the feedback information. In some embodiments, the second instruction may include at least one secret key. The at least one secret key may be used to trigger the operation mode. In some embodiments, the operation mode may include but limited to an energy-saving mode, a sleeping mode, or a working mode. For example, the first mode trigger unit 620 may generate an instruction for triggering the Tbox of the vehicle from the working mode to the sleeping mode. As example, the first mode trigger unit 620 may generate an instruction for triggering the Tbox of the vehicle from the sleeping mode to the working mode.

Merely for illustration, in some embodiments, the first acquisition module 510 may receive a first request for returning a vehicle to a station connected to a vehicle management platform from a first user terminal. The first processing unit 610 may generate the first instruction for processing the returning of the vehicle. The first transmitting module 530 may transmit the first instruction to the Tbox corresponding to an identifier included in the first request. In response to the received first instruction, the Tbox may perform the returning of the vehicle, and transmit feedback information regarding the returning of the vehicle. Upon receipt of the feedback information, the first mode trigger unit 620 may generate the second instruction for triggering the Tbox from a working mode to a sleeping mode. In response to the second instruction, the Tbox may be changed from the working mode to the sleeping mode. After finishing the returning of the vehicle, the Tbox may enter the sleeping mode. During the sleeping mode, the vehicle may just open the communication function in order to awaken the Tbox, while other functions may be closed, which may reduce power consumption of the Tbox and prolong the working life of the Tbox.

In some embodiments, when finishing the returning of the vehicle from the first user, the first processing unit 610 may generate at least one secret key corresponding to the Tbox of the vehicle. The first transmitting module 530 may transmit a secret key reset instruction to the Tbox. The secret key reset instruction includes the first secret key. The Tbox may reset the first secret key as a target secret key of the Tbox. When the second user desires to check out the vehicle from the vehicle management platform, the second user needs to request for the target secret key of the Tbox in order to unlock the vehicle. The target secret key of the Tbox may be dynamically updated, which may improve the safety of the vehicle. In some cases, the target secret key is always generated by Tbox itself, and keeps unchanged. Once a user obtains the target secret key, the user may use the secret key to unlock the vehicle again and again, which cause a great security risk of the vehicle. Therefore the dynamic updated secret key may improve the safety of the vehicle.

It should be noted that the above description of the processing device 112 is merely provided for the purposes of illustration, and not intended to limit the scope of the present disclosure. For persons having ordinary skills in the art, multiple variations and modifications may be made under the teachings of the present disclosure. For example, the processing device 112 may further include a storage module facilitating data storage. However, those variations and modifications do not depart from the scope of the present disclosure.

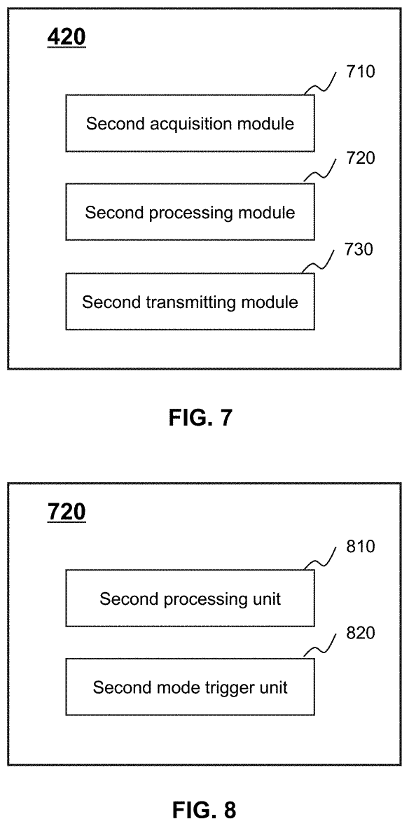

FIG. 7 is a block diagram illustrating an exemplary processing device on which an object may be implemented according to some embodiments of the present disclosure. The processor 420 may include a second acquisition module 710, a second processing module 720, and a second transmitting module 730. In some embodiments, the second processing module 720 may further include a second processing unit 810 and a second mode trigger unit 820 as illustrated in FIG. 8. The modules may be hardware circuits of at least part of the processor 420. The modules may also be implemented as an application or a set of instructions read and executed by the processor 420. Further, the modules may be any combination of the hardware circuits and the application/instructions. For example, the modules may be the part of the processor 420 when the processor 420 is executing the application/set of instructions.

The second acquisition module 710 may obtain data or information from the user terminal system 130 or the IoT platform 110. In some embodiments, the second acquisition module 710 may receive at least one instruction generated by the processing device 112. For example, the second acquisition module 710 may receive a first instruction for processing an action included in a service request. The action regarding an item may include returning the item, locking the item, checking out the item, or unlocking the item. In some embodiments, the item may include a vehicle, a bicycle, a drone, an aerocar, a wheelchair, a charger, or the like, or any combination thereof. The item may be controlled or managed by a target object connected to the IoT platform (e.g., the IoT platform 110). As another example, the second acquisition module 710 may receive a second instruction for triggering an operation mode of the target object (e.g., the Tbox of the vehicle).

The second processing unit 810 of the second processing module 720 may processing the action in response to the one or more instructions generated by the processing device 112. For example, the second processing unit 810 may perform one or more operations including returning the item, checking out the item, locking the item or unlocking the item. The second mode trigger unit 820 of the second processing module 720 may trigger an operation mode of the target object. For example, the second mode trigger unit 820 may trigger the target object from a working mode to a sleeping mode. As another example, the second trigger mode unit 820 may trigger the target object from the sleeping mode to the working mode.

The second transmitting module 730 may transmit data or information from the target object to the user terminal system 130 or the IoT platform 110. For example, when the second processing unit 810 finishing the action included in the service request, the second transmitting module 730 may transmit feedback information to the IoT platform 110 (e.g., the processing device 112 of the IoT platform 110 or the processor 220 of the IoT platform 110).

Merely for illustration, in some embodiments, the second acquisition module 710 may receive a first instruction for processing an action of returning a vehicle from a vehicle management platform. The second processing unit 810 may perform the action of returning the vehicle in response to the first instruction. The second transmitting module 730 may transmit feedback information regarding the vehicle to the vehicle management platform upon completion of the action of returning the vehicle. The second acquisition module 710 may receive a second instruction for triggering a mode change of a Tbox of the vehicle from a working mode to a sleeping mode. The second instruction may be generated by the vehicle management platform according to the feedback information. The second mode trigger unit 820 may trigger the mode change of the Tbox, for example, the second mode trigger 820 may trigger the Tbox from the working mode to the sleeping mode. More descriptions of triggering a mode change of the Tbox of the vehicle may be found elsewhere in the present disclosure (e.g., FIGS. 12-14, and the descriptions thereof).

In some embodiments, the second acquisition module 710 may receive an instruction from the vehicle management platform. The instruction may include a secret key configured to unlock the vehicle. The second processing unit 810 may reset the received secret key as a target secret key of the Tbox based on the instruction. The second processing unit 810 may perform a match operation between the target secret key and a secret key received from the user terminal. The second processing unit 810 may unlock the vehicle in response to a match result. More descriptions of unlocking the vehicle according to the secret key may be found elsewhere in the present disclosure (e.g., FIGS. 15-17, and the descriptions thereof).

It should be noted that the above description of the processor 420 is merely provided for the purposes of illustration, and not intended to limit the scope of the present disclosure. For persons having ordinary skills in the art, multiple variations and modifications may be made under the teachings of the present disclosure. For example, the processor 420 may further include a storage module facilitating data storage. However, those variations and modifications do not depart from the scope of the present disclosure.

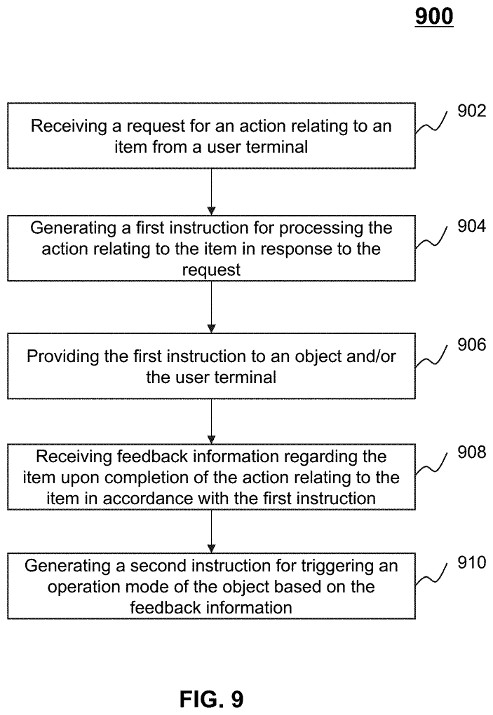

FIG. 9 is a flowchart illustrating an exemplary process for managing an item according to some embodiments of the present disclosure. In some embodiments, process 900 may be implemented on the IoT system 100. For example, the process 900 may be stored in the storage device 113 and/or the storage (e.g., the ROM 230, the RAM 240, or the storage 390) in the form of instructions, and invoked and/or executed by the server 111 (e.g., the processing device 112 of the server 111, or the processor 220 of the computing device 200).

In 902, the processor (e.g., the first acquisition module 510 of the processing device 112) may receive a request for an action relating to an item from a user terminal (e.g., the mobile device 130-1) of a requester. In some embodiments, the item may include a vehicle, a bicycle, a drone, an aerocar, a wheelchair, a charger, or the like, or any combination thereof. The item may be controlled or managed by a target object connected to the IoT platform (e.g., the IoT platform 110). For example, the target object may be a controller built in the item (e.g., a Tbox of a vehicle). The IoT platform may authorize the requester to use the object. In some embodiments, the target object (e.g., a controller) of the item may at least include a processing device configured to control the item. Taking a vehicle as an example, a Tbox of the vehicle may be configured to control or manage the vehicle (e.g., locking the vehicle, unlocking the vehicle, or triggering an operation mode of the Tbox) by performing one or more instructions from the IoT system 100. In some embodiments, the action relating to the item may include but not limited to returning the item, locking the item, checking out the item, or unlocking the item.

Merely for illustration, given that the item is a vehicle available to provided shared service (e.g., a shared car), the target object of the item is the Tbox of the vehicle, the vehicle may be managed by a vehicle management platform (i.e., the IoT platform). For example, the vehicle management platform provides one or more instructions to the Tbox of vehicle for further performing one or more operations (e.g., keeping the Tbox is in a sleeping mode, or awakening the Tbox). The vehicle management platform, the user terminal of the requester, and the Tbox of the vehicle may communicate with each other. The requester may request a service associated with the item connected to the IoT platform through the user terminal (or through an application installed in the user terminal). For example, the requester may request for checking out a vehicle from a station connected to the vehicle management platform. As another example, the requester may request for returning the vehicle to the station connected to the vehicle management platform when finishing using the vehicle. As a further example, the requester may request for unlocking the vehicle when desiring to check out the vehicle from the station. As a still further example, the requester may request for locking the vehicle when finishing returning the vehicle.

In 904, the processor (e.g., the first processing unit 610 of the first processing module 520 of the processing device 112) may generate a first instruction for processing the action relating to the item in response to the request. For example, the first processing unit 610 may parse the request, and determine the action to be processed. The first processing unit 610 may generate the first instruction for prompting the user terminal or of the target object of the item to process the action.

In some embodiments, the request may include user information regarding the requester, object information, and so on. For example, the user information may include an age, a gender, an authorization status, a credit history, contact information, or the like, or any combination thereof. The authorization status may indicate whether or not the user is qualified to use the item. As another example, the object information may include a unique identifier indicative of the object, a current operation mode, an availability status, or the like, or any combination thereof. The operation mode may include a working mode, a sleeping mode, or an energy-saving mode, and so on. The availability status may indicate whether or not the item is capable to be shared.

In 906, the processor (e.g., the first transmitting module 530 of the processing device 112) may provide the generated first instruction to the object and/or the user terminal. For example, the first transmitting module 530 may transmit the first instruction to a target item 140-1, and/or the mobile device 130-1 via the network.

In 908, the processor (e.g., the first acquisition module 510 of the processing device 112) may receive feedback information regarding the item upon completion of the action relating to the item in accordance with the first instruction. In some embodiments, the feedback information may include a unique identifier regarding the item, a location of the item, an execution time of the action, or the like, or any combination thereof.

For example, assuming that a requester requests for returning a vehicle to the station connected to the vehicle management platform when the requester finishes using the vehicle. The first processing unit 610 may generate the first instruction for prompting the vehicle (e.g., the Tbox of the vehicle) to process the returning operation (e.g., locking the vehicle, turning off the engine of the vehicle, etc.). Upon completion of the returning of the vehicle in accordance with the first instruction, a processor of the vehicle (e.g., the second transmitting module 730 of the processor 420) may send feedback information to the first acquisition module 510. The feedback information may include the unique identifier of the Tbox, a current location of the vehicle, a time of returning the vehicle, a vehicle usage condition (e.g., residual fuel, dump energy), or the like, or any combination thereof. Noted that the vehicle may be locked when the vehicle is returned to the station connected to the vehicle management platform, which may prevent an unauthorized user from using the vehicle. If a second requester desires to check out the vehicle from the station, the vehicle may need to be unlocked.

In 910, the processor (e.g., the first mode trigger unit 620 of the first processing module 520 of the processing device 112) may generate a second instruction for triggering or initiating an operation mode of the object based on the feedback information. For instance, upon receipt of the feedback information indicating the completion of the action, the first mode trigger unit 620 may generate the second instruction, and transmit the second instruction to the second acquisition module 710 of the object. The second acquisition module 710 may further transmit the second instruction to the second processing module 720. The second processing module 720 of the object may trigger the operation mode indicated by the second instruction. In some embodiments, the first processing module 520 may directly cause the object to change to the operation mode according to the second instruction.

In some embodiments, the operation mode may include the working mode, the sleeping mode, the energy-saving mode, or the like, or any combination thereof. The working mode means that the object is in normal operation condition, for example, a display of a Tbox of a vehicle is lightened at a relatively high power when the Tbox is in the working mode. The sleeping mode means that the object is in a low power condition, for example, the display of Tbox of the vehicle is lightened at a relatively low power when the Tbox is in the sleeping mode. The energy-saving model means that the object is in an energy-saving condition, for example, at least a portion of the Tbox operates, and/or at least a portion of the Tbox operates at a reduced capacity or stops operating. For instance, under the energy-saving mode, the Tbox may communicate with the vehicle management platform periodically instead of real-time communicating with the vehicle management platform. As another example, under the energy-saving mode, the Tbox may turn off a portion of functions, for example, turning off the display device or a data reporting device connected to the vehicle management platform. When the data reporting device is turned off, the Tbox may store data in a local storage (e.g., the storage device 430) instead of reporting the data to the vehicle management platform. In some embodiments, the energy-saving mode may include the sleeping mode.

In some embodiments, if the second instruction indicates that the object need be changed to the energy-saving mode, the second processing module 720 may trigger the energy-saving mode of the object based on the second instruction. If the second instruction indicates that the object need be changed to the working mode, the second processing module 720 may trigger the working mode of the object based on the second instruction.

In some embodiments, the second instruction may include the instruction for triggering the operation mode of the object and a secret key. The secret key may be used to change the current operation mode to a second operation mode. Specifically, the secret key may be transmitted to the second acquisition module 710 of the object. The secret key may be stored in a storage device (e.g., the storage device 430 of the object). As used herein, the secret key stored in the storage device 430 may be referred to as a first secret key. In some embodiments, when the second acquisition module 710 receives a second secret key, the second processing module 720 may perform a matching operation between the first secret key and the second secret key. If the first secret key matches with the second secret key, the second processing module 720 may trigger the object from the current operation mode (e.g., the energy-saving mode) to the second operation mode (e.g., the working mode). If the first secret key does not match with the second secret key, the second processing module 720 may refuse to trigger the object from the current operation mode (e.g., the energy-saving mode) to the second operation mode (e.g., the working mode). The second secret key may be generated by the first processing module 520 when the first acquisition module 510 receives a request for checking out the item from a second user terminal. The second acquisition module 710 may obtain the second secret key from the second user terminal. In some embodiments, the first secret key and the second secret key may include Bluetooth pairing codes, or message verification codes.

In some embodiments, the second instruction may further include the instruction for locking the item (e.g., locking a power engine of a vehicle) and a third secret key. The third secret key may be used to unlock the item (e.g., unlocking the power engine of the vehicle). Specifically, the third secret key may be transmitted to the second acquisition module 710 of the object. The third secret key may be stored in a storage device (e.g., the storage device 430). In some embodiments, the item may be locked in accordance with the second instruction when the item is returned to the station connected to the IoT platform. When the second acquisition module 710 receives a fourth secret key, the second processing module 720 may perform a matching operation between the third secret key and the fourth secret key. If the third secret key matches with the fourth secret key, the second processing module 720 may unlock the item. If the third secret key does not match with the fourth secret key, the second processing module 720 may refuse to unlock the item. The fourth secret key may be generated by the first processing module 520 when the first acquisition module 510 receives the request for checking out or unlocking the item from the second user terminal. The second acquisition module 710 may obtain the fourth secret key from the second user terminal. In some embodiments, the third secret key and the fourth secret key may include Bluetooth pairing codes or message verification codes.

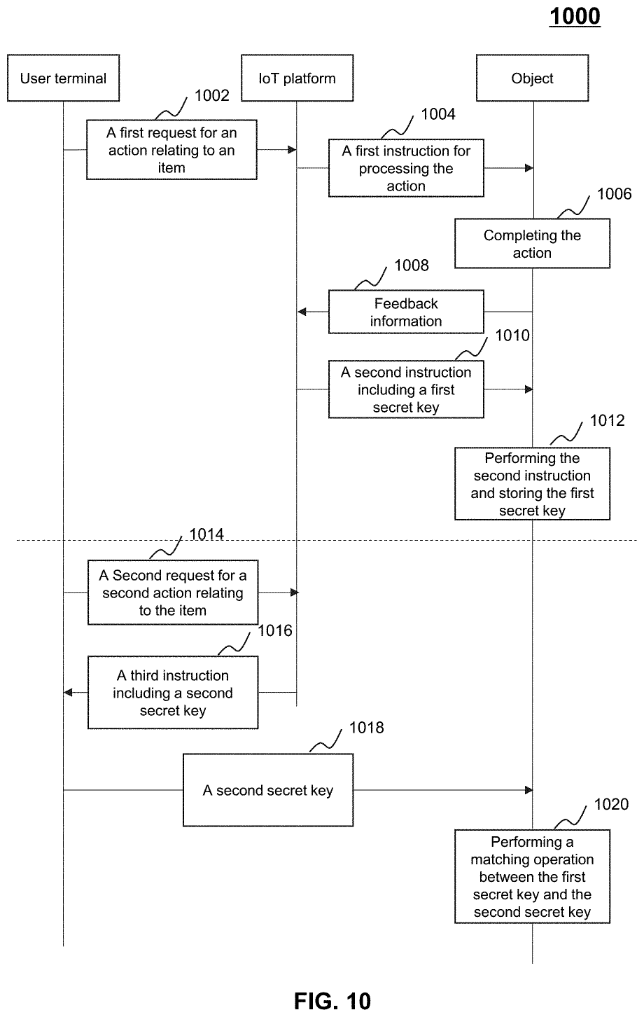

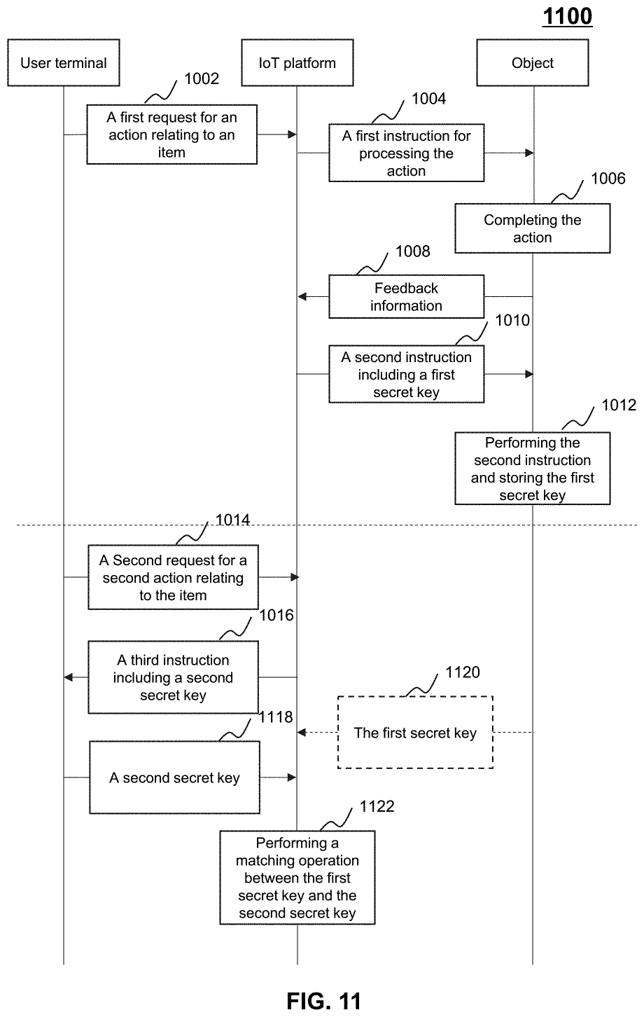

FIGS. 10-11 are flowcharts illustrating exemplary pipeline processes for managing an item according to some embodiments of the present disclosure. The pipeline process 1000 illustrated in FIG. 10 and the pipeline process illustrated in FIG. 11 show the interaction among a user terminal, an IoT platform, and an object of the item. As described in connection with FIG. 9, the IoT platform may communicate with the user terminal of the requester and the object of the item that the requester wants. As used herein, the object (e.g., a controller) of the item may at least include a processing device configured to control the item. Taking a vehicle as an example, a Tbox of the vehicle may be configured to control or manage the vehicle (e.g., locking the vehicle, unlocking the vehicle, or triggering an operation mode of the Tbox) by performing one or more instructions from the IoT system 100.

In 1002, a first user terminal may transmit a first request for an action relating to an item. The first request may be transmitted to the IoT platform (e.g., the first acquisition module 510). For example, the first user terminal transmits the first request for returning the item to a station connected to the IoT platform. The item itself may also be connected to the IoT platform, and may communicate with the IoT platform directly without going through a station connected to the IoT platform.

In 1004, the IoT platform (e.g., the first processing module 520) may generate a first instruction for processing the action in response to the first request from the first user terminal. The IoT platform (e.g., the first transmitting module 530) may further transmit the first instruction to the object of the item (e.g., the second acquisition module 710).

In 1006, the object (e.g., the second processing module 720) may complete the action indicated by the first request in accordance with the first instruction. For example, the second processing module 720 may direct the object to complete the returning of the item (e.g., locking an engine of the item).

In 1008, upon completion of the action, the object (e.g., the second transmitting module 730) may transmit feedback information regarding the item to the IoT platform. The feedback information may include a unique identifier regarding the item, a location of the item, an execution time of the action, or the like, or any combination thereof.

In 1010, upon receipt of the feedback information, the IoT platform (e.g., the first processing module 520) may generate a second instruction for triggering an operation mode of the object, and transmit the second instruction to object.

In some embodiments, the second instruction may be used to trigger the energy-saving mode of the object (e.g., the Tbox of the vehicle). In some embodiments, the second instruction may include at least one first secret key. The at least one first secret key may include a Bluetooth pairing code or a message verification code.

In 1012, in response to the second instruction, the object (e.g., the second processing module 720) may perform the second instruction and store the at least one secret key in a storage device (e.g., the storage device 430). For example, the second processing module 720 may direct the object to change to the operation mode indicated by the second instruction (e.g., the energy-saving mode). As used herein, the operation mode indicated by the second instruction refers to as a first operation mode.

In 1014, a second user terminal may transmit a second request for a second action relating to the item to the IoT platform. The second request may be transmitted to the IoT platform (e.g., the first acquisition module 510). For example, the second user terminal transmits the second request for checking out the object from the station in connection with the IoT platform.

In 1016, the IoT platform (e.g., the first processing module 520) may generate a third instruction, and transmit the third instruction to the second user terminal. The third instruction may include an instruction for changing the object from the first operation mode to a second operation mode. The third instruction may include a second secret key. In some embodiments, the first operation mode is the energy-saving mode, and the second operation mode is the working mode.

In 1018, the second user terminal may transmit the generated second secret key directly to the object.

In 1020, the object (e.g., the second acquisition module 710) may receive the second secret key, and perform a matching operation between the first secret key and the second secret key. For example, assuming that the first secret key includes a first Bluetooth pairing code, and the second secret key includes a second Bluetooth pairing code, the second processing module 720 may determine whether or not the first Bluetooth pairing code and the second Bluetooth pairing code are matched successfully. In some embodiments, if the first Bluetooth pairing code may be the same as the second Bluetooth pairing code, which means the first Bluetooth pairing code matches with the second Bluetooth pairing code.

In some embodiments, if the first secret key matches with the second secret key, the operation mode of the object may be changed to the second operation mode. For example, the second processing module 720 may trigger the object from the energy-saving mode to the working mode.

In some embodiments, if the first secret key does not match with the second secret key, the object may refuse to change the current operation mode, and the operation mode of the object may remain unchanged (e.g., the object keeps in the first operation mode (e.g., the energy-saving mode)). The object (e.g., the second transmitting module 730) may transmit information indicative of a failed match to the IoT platform.

In some embodiments, as illustrated in 1118 and 1120 of FIG. 11, the IoT platform (e.g., the first acquisition module 510) may receive the second secret key and the first secret key from the second user terminal and the object, respectively. The IoT platform (e.g., the first processing module 520) may perform the matching operation between the first secret key and the second secret key. If the first secret key matches with the second secret key, the first processing module 520 may also direct the object to change the energy-saving mode to the working mode.

In some embodiments, the second instruction may also include an instruction for locking the item (e.g., locking the engine of the vehicle). For example, when the item is returned to the station connected the IoT platform, the item may need to be locked. The object may perform the locking operation in accordance with the second instruction. For example, the Tbox may lock the engine of the vehicle in response to the second instruction. In some embodiments, the second instruction may include a third secret key. The third secret key may be used to unlock the object. The third secret key may be stored in a storage device (e.g., the storage device 430).

When the IoT platform receives the second request for checking out the item from the second user terminal, the IoT platform may send the third instruction to the second user terminal. The third instruction may further include an instruction for unlocking the item. In some embodiments, the third instruction may include a fourth secret key. The item may be unlocked based on a relationship of the third secret key and the fourth secret key. The second user terminal may transmit the fourth secret key to the object. In some embodiments, the object may perform the matching operation between the third secret key and the fourth secret key. For example, assuming that the third secret key includes a third Bluetooth pairing code, and the fourth secret key includes a fourth Bluetooth pairing code, the second processing module 720 of the object may determine whether or not the third Bluetooth pairing code and the fourth Bluetooth pairing code are matched successfully. In some embodiments, if the third Bluetooth pairing code may be the same as the fourth Bluetooth pairing code, which means the third Bluetooth pairing code matches with the fourth Bluetooth pairing code. In some embodiments, if the third Bluetooth pairing code matches with the fourth Bluetooth pairing code, the item may be unlocked. After unlocking the item, the second user may be free to utilize the item.

To facilitate understanding of the present disclosure, various examples may be provided. For example, the IoT platform 100 may be provided as a vehicle management system configured to provide shared use of the vehicle. The shared vehicles may be managed and controlled through the vehicle management system. Specifically, the vehicle managing system may control a telematics processor (also referred to as “Telematics Box,” which is called “Tbox” for short) of the vehicle to achieve the control of the vehicle.

The following examples are provided for illustration purposes and not intended to be limiting.

### EXAMPLE ONE

FIG. 12 illustrates an exemplary process for controlling a Tbox of a vehicle according to some embodiments of the present disclosure. The embodiment of the present disclosure provides the Tbox controlling process/method 1200 for resolving an issue or other issues caused by large power consumption of the Tbox, because the Tbox needs to maintain the connection with the vehicle management platform. In some embodiments, the process 1200 may be stored in the storage device 113 and/or the storage (e.g., the ROM 230, the RAM 240, or the storage 390) in the form of instructions, and invoked and/or executed by the server 111 (e.g., the processing device 112 of the server 111, or the processor 220 of the computing device 200).

In 1202, the processor (e.g., the first acquisition module 510 of the processing device 112) may receive a request for an action of returning a vehicle from a user terminal of a requester. The request may include an identifier of the Tbox of the vehicle.

If the requester finishes using the vehicle, the requester transmits the request for returning the vehicle to the vehicle management platform via her/his user terminal (e.g., an application installed in the user terminal). The request includes the identifier corresponding to the Tbox of the vehicle. The identifier may be a unique identifier corresponding to Tbox of the vehicle. The identifier may be used to identify the Tbox of the vehicle. Specifically, the unique identifier may be in various forms, such as a string, a character, an image, a numeral, and so on.

In 1204, the processor (e.g., the first processing unit 610 of the first processing module 520 of the processing device 112) may generate a first instruction for processing the action of returning the vehicle in response to the request.

In 1206, the processor (e.g., the first transmitting module 530 of the processing device 112) may provide/transmit the first instruction to the Tbox of the vehicle (e.g., the second acquisition module 710). The first instruction may be used to direct the Tbox to process the returning of the vehicle, and feed back information regarding the returning of the vehicle.

For example, the vehicle management platform transmits the first instruction to the Tbox of the corresponding vehicle according to the identifier included in the request.

In 1208, the processor (e.g., the first acquisition module 510 of the processing device 112) may receive feedback information regarding the vehicle upon completion of the action in accordance with the first instruction.

For example, after receiving the request for returning the vehicle from the user terminal, the vehicle management platform transmits the first instruction to the Tbox corresponding to the identifier. After receiving the first instruction, the Tbox performs a preset procedure for returning the vehicle (e.g., locking the vehicle), and obtains the feedback information regarding the returning of the vehicle, then transmits the feedback information to the vehicle management platform.

In some embodiments, the feedback information may include the unique identifier of the Tbox of the vehicle, a current location of the vehicle, a time of returning the vehicle, a vehicle usage condition (e.g., residual fuel, dump energy), or the like, or any combination thereof.

In 1210, the processor (e.g., the first mode trigger unit 620 of the first processing module 520 of the processing device 112) may generate, based on the feedback information, a second instruction for triggering a mode change of the Tbox from the working mode to the sleeping mode.

For example, after receiving the feedback information, the vehicle management platform transmits the second instruction for triggering the sleeping mode to the Tbox of the vehicle. The Tbox may be changed from the working mode to the sleeping mode in response to the second instruction. During the sleeping mode, at least one communication functional component (e.g., the second transmitting module 730) of the Tbox keeps working, so that the Tbox may be awakened in response to an instruction for triggering the working mode received by the at least one communication functional component. While other functional components may be closed and enter the sleeping mode, for example, turning off the power engine of the vehicle, turning off a display device of the Tbox, turning off the voice command system, turning off GPS, stopping real-time data exchange with the vehicle management platform, etc.

Additional or alternatively, after receiving the feedback information from Tbox, the vehicle management platform may store the feedback information in a storage device (e.g., the storage device 113), and finish the process of returning the vehicle.

As described in connection with FIG.12, the vehicle management platform may receive a first request for returning the vehicle from a first user terminal. The vehicle management platform may generate and transmit the first instruction to the Tbox corresponding to the identifier included in the first request. The first instruction may be used to process the returning of the vehicle. In response to the received first instruction, the Tbox may perform the returning of the vehicle, and transmit feedback information regarding the returning of the vehicle. Upon receipt of the feedback information, the vehicle management platform may generate the second instruction for triggering the Tbox from the working mode to the sleeping mode. In response to the second instruction, the Tbox may be changed from the working mode to the sleeping mode. After finishing the returning of the vehicle, the Tbox may enter the sleeping mode. During the sleeping mode, the vehicle may just open the communication function in order to awaken the Tbox, while other functions may be closed, which may reduce power consumption of the Tbox and prolong the working life of the Tbox.

### EXAMPLE TWO

On the basis of the foregoing descriptions of the process 1200 illustrated in FIG. 12, in certain embodiments, after receiving a second request for checking out the vehicle from the vehicle management platform, the vehicle management platform may awaken the Tbox, that is, the Tbox may be changed from the sleeping mode to the working mode. It should be noted that, in different scenarios, the vehicle management platform may awaken the Tbox by various ways, so that the Tbox may be switched to the working mode.

In some embodiments, if a second user desires to check out the vehicle from the vehicle management platform, or a vehicle dispatcher desires to move the vehicle, the second user or the vehicle dispatcher may awaken the Tbox of the vehicle by his/her user terminal (or an application installed in his/her user terminal).

In some embodiments, the user terminal may be a mobile device that installs a client application in connection with the vehicle management platform, for example, a mobile phone of the user. The user may check out/return the vehicle through the client application. In some embodiments, the user terminal may be a mobile device that installs a server application in connection with the vehicle management platform. The vehicle dispatcher may launch or manage the vehicle through the server application.

In some embodiments, before the Tbox enters the sleeping mode, the vehicle management platform may transmit a first secret key (e.g., a first Bluetooth pairing code) for triggering the Tbox from the sleeping mode to the working mode to the Tbox. During the Tbox enters the sleeping mode, if the vehicle management platform receives a request for checking out the vehicle, the vehicle management platform may transmit a second secret key (e.g., a second Bluetooth pairing code) to the user terminal. The requester may request for pairing with the first secret key and the second secret key. The Tbox may determine whether or not the second secret key matches with the first secret key. If the second secret key matches with the first secret key, the Tbox may be changed from the sleeping mode to the working mode, that is, the Tbox is awakened. If the second secret key does not match with the first secret key, the Tbox may not be changed to the working mode, and remain the sleeping mode.

In some embodiments, after receiving the feedback information regarding the returning of vehicle, the vehicle management platform may generate the first secret key, and transmit the first secret key to the Tbox, then the Tbox may store the first secret key in a storage device (e.g., the storage device 430). The first secret key may be included in the second instruction.

In some embodiments, the vehicle management platform may generate, according to a preset rule, the secret key(s) corresponding to the Tbox, for example, the first secret key and the second secret key. In some embodiments, a technician may preset the first secret key and the second secret key according to the preset rule through the vehicle management platform. For example, the first secret key may include the first Bluetooth pairing code, the first Bluetooth pairing code includes six digits. The second secret key may also include the second Bluetooth pairing code, and the second secret key may be the same as the first secret key. It should be noted that the vehicle management platform generates the secret key by various ways, and not intended to be limiting.

In some embodiments, after receiving the feedback information regarding the returning of the vehicle and before transmitting the second instruction to the Tbox, the vehicle management platform may transmit the first secret key to the Tbox, so that the Tbox may receive and store the first secret key before the Tbox enters the sleeping mode.

In some embodiments, after receiving the feedback information regarding the returning of the vehicle, the first secret key may be carried in the second instruction, the vehicle management platform may transmit the second instruction including the first secret key to the Tbox. The Tbox may store the first secret key in the storage device. At the same time, the Tbox may be changed from the working mode to the sleeping mode in accordance with the second instruction.

In some embodiments, during the Tbox enters the sleeping mode, a component configured to facilitate Bluetooth communication may be always open. The vehicle management platform may awaken the Tbox by way of the Bluetooth communication. For example, the vehicle management platform receives the request for checking out the vehicle from the user terminal; the request includes the identifier corresponding to the Tbox of the vehicle. The vehicle management platform may provide the second secret key corresponding to the Tbox of the vehicle according to the identifier. The second secret key corresponds to the first secret key. The vehicle management platform may transmit the second secret key to the user terminal. The user terminal may awaken the Tbox by using the second secret key, and the Tbox is changed from the sleeping mode to the working mode.

In some embodiments, after awakening the Tbox, the vehicle management platform may generate a new first secret key and a new second secret key corresponding to the Tbox respectively, and store the new first secret key and the new second secret key. The vehicle management platform may transmit the new first secret key to the Tbox to update the first secret key stored in the Tbox, which may prevent the user uses the old secret key to awaken the Tbox again, and use the vehicle illegally. Thus the security of the vehicle may be improved.

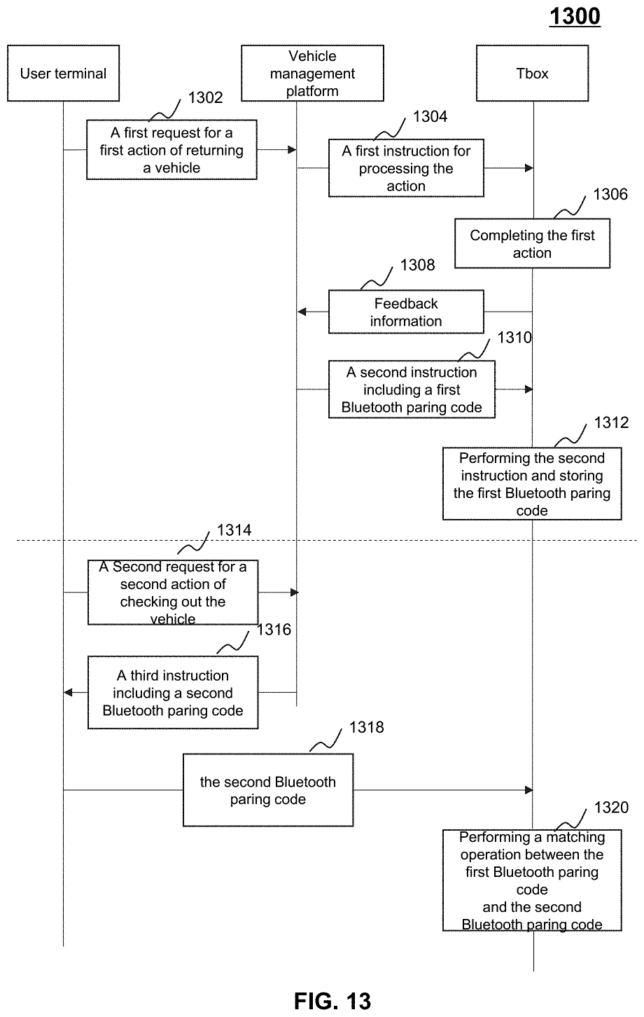

FIG. 13 is a flowchart illustrating an exemplary pipeline process for controlling a Tbox of a vehicle according to some embodiments of the present disclosure. As illustrated in the pipeline process 1300 in FIG. 13, the user terminal, the vehicle management platform, and the Tbox of the vehicle may be communicated with each other as follows:

In 1302, the vehicle management platform may receive a first request for a first action of returning the vehicle. For example, a first user terminal transmits the first request to the vehicle management platform, and the vehicle management platform receives the first request.

In 1304, the vehicle management platform may generate and transmit a first instruction for processing the action to the Tbox of the vehicle. As used herein, the first instruction may be used to direct the Tbox to return the vehicle to the station connected to the vehicle management platform. The vehicle management platform may identify the Tbox of the vehicle according to the identifier of the Tbox included in the first request, and transmit the first instruction to the corresponding Tbox.

In 1306, the Tbox may complete the first action. For example, the first instruction prompts the Tbox of the vehicle to perform the returning of the vehicle, such as clearing fee, or locking the vehicle.

In 1308, the Tbox may transmit feedback information regarding the returning of the vehicle to the vehicle management platform.

In 1310, the vehicle management platform may generate and transmit a second instruction including a first Bluetooth pairing code to the Tbox of the vehicle.

In 1312, the Tbox may perform the second instruction, for example, change the working mode to the sleeping mode, and store the first Bluetooth pairing code.

In 1314, the vehicle management platform may receive a second request for a second action of checking out the vehicle. For example, a second user terminal transmits the second request to the vehicle management platform, and the vehicle management platform receives the second request.

In 1316, in response to the second request, the vehicle management platform may generate and transmit a third instruction including a second Bluetooth pairing code to the second user terminal.

In 1318, the second user terminal may transmit the second Bluetooth pairing code to the Tbox, and request for a Bluetooth pairing with the second Bluetooth pairing code and the first Bluetooth pairing code.

In 1320, in response to the Bluetooth pairing, the Tbox may perform a matching operation between the second Bluetooth pairing code and the first Bluetooth pairing code. If the second Bluetooth pairing code matches with the first Bluetooth pairing code, the Tbox may be changed from the sleeping mode to the working mode.

It should be noted that, as illustrated in FIG. 13, the operations 1302-1312 above the dotted line illustrate a first process of controlling the Tbox from the working mode to sleeping mode, the operations 1314-1320 below the dotted line illustrate a second process of awakening the Tbox from the sleeping mode to the working mode.

If the vehicle management platform desires to awaken the Tbox of the vehicle in order to obtain real-time data regarding the vehicle, or the vehicle dispatcher desires to remotely control the vehicle via the vehicle management platform, in these cases, the vehicle management platform may directly awaken the Tbox. Specifically, during the Tbox enters the sleeping mode, a component configured to facilitate message communication may always remain open. The vehicle platform may awaken the Tbox by a way of the message communication.

For example, the vehicle management platform receives an instruction for controlling the vehicle from the vehicle dispatcher; the instruction includes an identifier of the Tbox of the vehicle. The vehicle management platform may transmit a message verification code to the Tbox corresponding to the identifier. Upon receipt of the message verification code, the Tbox may verify the message verification code. If the message verification code is verified successfully, the Tbox may be changed from the sleeping mode to the working mode. In some embodiments, the message verification code may exist in various forms, such as a string, a character, an image, a numeral, and so on.

### EXAMPLE THREE

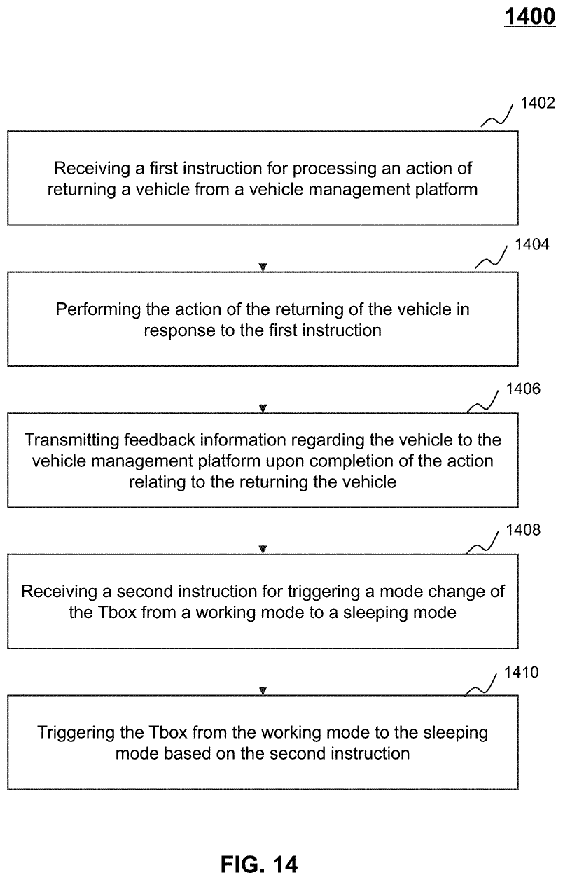

FIG. 14 is a flowchart illustrating an exemplary process for controlling a Tbox of a vehicle according to some embodiments of the present disclosure. This example provides the Tbox controlling process/method 1400 for resolving an issue or other issues caused by large power consumption of the Tbox, because the Tbox needs to maintain the connection with the vehicle management platform. The process 1400 may be implemented on a target object of an item (e.g., the Tbox of the vehicle). In some embodiments, the process 1400 may be stored in the storage device 430 in the form of instructions, and invoked and/or executed by the processor 420.

In 1402, the processor (e.g., the second acquisition module 710 of the processor 420) may receive a first instruction for processing an action of returning a vehicle from a vehicle management platform.

As described in connection with FIGS. 12-13, when a first requester finishes using the vehicle, the first requester transmits the first request for returning the vehicle to the station connected to the vehicle management platform. The first request includes an identifier corresponding to the Tbox of the vehicle. The identifier may be a unique identifier corresponding to Tbox of the vehicle, which is used to identify the Tbox of the vehicle. The unique identifier may exist in various forms, such as a string, a character, an image, a numeral, and so on. In response to the first request, the vehicle management platform may provide the first instruction to the Tbox corresponding to the identifier. As used herein, the first instruction may be used to direct the Tbox to perform the returning of the vehicle.

In 1404, the processor (e.g., the second processing unit 810 of the second processing module 720 of the processor 420) may perform the action of the returning of the vehicle in response to the first instruction. The second processing unit 810 may further generate feedback information regarding the returning of the vehicle.

In 1406, upon completion of the action relating to the returning the vehicle, the processor (e.g., the second transmitting module 730 of the processor 420) may transmit the feedback information regarding the vehicle to the vehicle management platform.

Specifically, the first instruction may prompt the Tbox to perform the returning of the vehicle (e.g., clearing fee, locking the vehicle), and generate the feedback information regarding the returning of the vehicle, then transmit the feedback information to the vehicle management platform.

In some embodiments, the feedback information may include the unique identifier of the Tbox of the vehicle, a current location of the vehicle, a time of returning the vehicle, a vehicle usage condition (e.g., residual fuel, dump energy), or the like, or any combination thereof.

In 1408, the processor (e.g., the second acquisition module 710 of the processor 420 of the Tbox) may receive a second instruction for triggering a mode change of the Tbox from a working mode to a sleeping mode, from the vehicle management platform. For example, the vehicle management platform may generate and transmit the second instruction to the Tbox after receiving the feedback information. As used herein, the second instruction may be used to trigger the sleeping mode.

In 1410, the processor (e.g., the second mode trigger unit 820 of the second processing module 720 of the processor 420 of the Tbox) may trigger the Tbox from the working mode to the sleeping mode based on the second instruction.

During the sleeping mode, at least one communication component (e.g., the second transmitting module 730) of the Tbox may keep working, so that the Tbox may be awakened in response to an instruction for triggering the working mode received by the at least one communication functional component. While other functional components may be closed and enter the sleeping mode, for example, turning off the power engine of the vehicle, turning off a display device of the Tbox, turning off the voice command system, turning off the GPS, stopping data exchange with the vehicle management platform, etc.

As described in connection with FIG. 14, the vehicle management platform may receive a first request for returning the vehicle from a first user terminal. The vehicle management platform may generate and transmit the first instruction to the Tbox corresponding to the identifier included in the first request. The first instruction may be used to process the returning of the vehicle. In response to the received first instruction, the Tbox may perform the returning of the vehicle, and transmit feedback information regarding the returning of the vehicle. Upon receipt of the feedback information, the vehicle management platform may generate the second instruction for triggering the Tbox from the working mode to the sleeping mode. In response to the second instruction, the Tbox may be changed from the working mode to the sleeping mode. After finishing the returning of the vehicle, the Tbox may enter the sleeping mode. During the sleeping mode, the vehicle may just open the communication function in order to awaken the Tbox, while other functions may be closed, which may reduce power consumption of the Tbox and prolong the working life of the Tbox.

### EXAMPLE FOUR

On the basis of the foregoing descriptions of the process 1400 illustrated in FIG. 14, after the Tbox enters the sleeping mode, in different scenarios, the Tbox may be awakened by various ways, and the Tbox is switched to the working mode.

In some embodiments, if a second user desires to check out the vehicle from the vehicle management platform, or a vehicle dispatcher desires to move the vehicle, the second user or the vehicle dispatcher may awaken the Tbox of the vehicle by his/her user terminal (or an application installed in his/her user terminal).

In some embodiments, the user terminal may be a mobile device that installs a client application in connection with the vehicle management platform, for example, a mobile phone of the user. The user may check out/return the vehicle through the client application. In some embodiments, the user terminal may be a mobile device that installs a server application in connection with the vehicle management platform. The vehicle dispatcher may launch or manage the vehicle through the server application.

In some embodiments, after receiving the feedback information regarding the returning of the vehicle, and before the Tbox enters the sleeping mode, the Tbox may receive the first secret key (e.g., the first Bluetooth pairing code) for triggering the working mode, and store the first secret key. When the second user desires to check out the vehicle from the vehicle management platform, the second user may send the second request for checking out the vehicle from the vehicle management platform through the second user terminal. The request includes the identifier corresponding to the Tbox of the vehicle. The vehicle management platform may provide the second secret key (e.g., a second Bluetooth pairing code) corresponding to the Tbox, and transmit the second secret key to the second user terminal.

After receiving the second secret key (e.g., the second Bluetooth pairing code), the second user terminal transmits an instruction for awakening the Tbox, and the instruction includes the second secret key. Specifically, the second user terminal transmits the second secret key to the Tbox, and requests for the pairing between the second secret key and the first secret key. Then the Tbox may perform the matching operation between the second secret key and the first secret key. If the second secret key matches with the first secret key, the Tbox may be changed from the sleeping mode to the working mode, that is, the Tbox is awakened. If the second secret key does not match with the first secret key, the Tbox may not be changed to the working mode, and remain the sleeping mode.

In some embodiments, if the vehicle management platform desires to awaken the Tbox of the vehicle in order to obtain real-time data regarding the vehicle, or the vehicle dispatcher desires to remotely control the vehicle via the vehicle management platform, in these cases, the vehicle management platform may directly awaken the Tbox. Specifically, during the Tbox enters the sleeping mode, a component configured to facilitate message communication may always remain on. The vehicle platform may awaken the Tbox by way of the message communication.

For example, the vehicle management platform receives an instruction for controlling the vehicle from the vehicle dispatcher; the instruction includes an identifier of the Tbox of the vehicle. The vehicle management platform may transmit a message verification code to the Tbox corresponding to the identifier. Upon receipt of the message verification code, the Tbox may verify the message verification code. If the message verification code is verified successfully, the Tbox may be changed from the sleeping mode to the working mode. If the message verification code is verified unsuccessfully, the Tbox may remain the sleeping mode. In some embodiments, the message verification code may exist in various forms, such as a string, a character, an image, a numeral, and so on.

In some embodiments, during the Tbox enters the sleeping mode, if the vehicle collides with something else (e.g., another car, a wall), the Tbox may be changed from the sleeping mode to the working mode automatically. Specifically, the Tbox may detect a vibration state of the vehicle. The Tbox may be changed from the sleeping mode to the working mode based on the vibration state of the vehicle. For example, the vibration state of the vehicle may be classified into one or more levels, for example, a low level indicative of slight vibration, a high level indicative of violent vibration. When the high level is detected by a vibration sensor connected to the Tbox, the Tbox may be changed from the sleeping mode to the working mode. In some embodiments, the Tbox may report the detected vibration state to the vehicle management platform.

In some embodiments, during the Tbox of the vehicle enters the sleeping mode, a component configured to facilitate data exchange with a vibration sensor of the vehicle may be turned on. When the vibration sensor detects the vibration of the vehicle, the vibration sensor may transmit data regarding the vibration to the Tbox. Upon receipt of the data regarding the vibration, the Tbox may be changed from the sleeping mode to the working mode. At the same time, the Tbox may transmit or report the data regarding the vibration to the vehicle management platform.

### EXAMPLE FIVE

The vehicle management platform communicates with the Tbox, obtains various data regarding the vehicle from the Tbox (e.g., current state data of the vehicle, including whether the vehicle door is closed, whether the door lock is locked, whether the power lock is locked, etc.), and controls the vehicle to perform various operations (such as unlock the power lock, close the vehicle door, close the vehicle window, etc.). The vehicle management platform also communicates with the user terminal, so that in response to various service requests from the user terminal (e.g., reserve a vehicle, unlock a vehicle, open a vehicle door, etc.). The vehicle management platform communicates with one or more Tboxes or one or more user terminals.

FIG. 15 is a flowchart illustrating an exemplary process for unlocking a vehicle according to some embodiments of the present disclosure. Process 1500 illustrated in FIG. 15 may be implemented on the IoT system 100 (e.g., the vehicle management platform). In some embodiments, the process 1500 may be stored in the storage device 113 and/or the storage (e.g., the ROM 230, the RAM 240, or the storage 390) in the form of instructions, and invoked and/or executed by the server 111 (e.g., the processing device 112 of the server 111, or the processor 220 of the computing device 200).

In 1502, the processor (e.g., the first acquisition module 510 of the processing device 112) may receive a request for an action of returning the vehicle from a user terminal, and the request includes an identifier of the Tbox of the vehicle.

In 1504, the processor (e.g., the first processing module 520 of the processing device 112) may generate at least one secret key upon receipt of the request. In some embodiments, the at least one secret key may include the Bluetooth pairing code. In some embodiments, the at least one secret key may include a first secret key and/or a second secret key, which are used to unlock the vehicle.

When a first user finishes using the vehicle and desires to return the vehicle, the first user may use the first user terminal to transmit the request for returning the vehicle to the vehicle management platform. Upon receipt of the request for returning the vehicle, the vehicle management platform may generate the at least one secret key corresponding to the vehicle. The vehicle management platform may generate the secret key in various ways. The above example is not intended to be limiting.

In some embodiments, the vehicle management platform may store a corresponding relation between the at least one secret key and the identifier of the Tbox of the vehicle. If the first user fails to unlock the vehicle, the vehicle management platform may reset a new secret key based on the stored relation.

In 1506, the processor (e.g., the first transmitting module 530 of the processing device 112) may provide an instruction including the at least one secret key to the Tbox. As used herein, the instruction is referred to as secret key reset instruction. The secret key reset instruction may be used to direct the Tbox to reset the provided secret key as its target secret key. For example, the secret key reset instruction prompts the Tbox to reset the first secret key as the target secret key that is used to unlock the vehicle.

When the vehicle management platform generates the secret key corresponding to the vehicle, the vehicle management platform may transmit the secret key reset instruction including the generated secret key to the Tbox of the vehicle. Then the Tbox perform the secret key reset instruction to reset the secret key.

In some embodiments, the corresponding relation between the identifier of the Tbox and the Tbox may be stored in a storage device of the vehicle management platform (e.g., the storage device 113). After the vehicle management platform generates the at least one secret key, the vehicle management platform may retrieve the Tbox corresponding to the identifier included in the request. The vehicle management platform may communicate with the Tbox via the network. The vehicle management platform may transmit the secret key reset instruction to the Tbox. After receiving the secret key reset instruction, the Tbox may reset the received secret key as its new secret key (i.e., the target secret key) in order to replace its old secret key, which may achieve dynamic update of the secret key. When the vehicle is used again, the user needs to use the new secret key to unlock the vehicle, which may improve the safety of the vehicle to avoid illegal use.

In some embodiments, the at least one secret key may include a first Bluetooth pairing code. When a second user desires to check out the vehicle from the vehicle management platform, the vehicle management platform may transmit the first Bluetooth pairing code to the second user terminal of the second user. The second user may request for a Bluetooth pairing between the first Bluetooth pairing code and the Bluetooth pairing code stored in the Tbox. If the pairing is successful, the vehicle is unlocked.

In some embodiments, the at least one secret key may include a second Bluetooth pairing code. When the second user desires to check out the vehicle from the vehicle management platform, the vehicle management platform may transmit the second Bluetooth pairing code to the second user terminal of the second user. The second user may request for a Bluetooth pairing between the second Bluetooth pairing code and the Bluetooth pairing code stored in the Tbox of the vehicle. If the pairing is successful, the vehicle is unlocked.

As described in connection with FIG. 15, when finishing the returning of the vehicle, the vehicle management platform may generate at least one secret key corresponding to the Tbox of the vehicle. The vehicle management platform may provide the secret key reset instruction to the Tbox. The secret key reset instruction includes the generated at least one secret key. The Tbox may reset the generated at least one secret key as the target secret key of the Tbox. When a second user desires to check out the vehicle from the vehicle management platform, the second user needs to request for the target secret key of the Tbox in order to unlock the vehicle. The target secret key of the Tbox may be dynamically updated as described in FIG. 15, which may improve the safety of the vehicle. In some cases, the target secret key is always generated by Tbox itself, and keeps unchanged. Once a user obtains the target secret key, the user may use the secret key to unlock the vehicle again and again, which cause a great security risk of the vehicle. Therefore the dynamic updated secret key may improve the safety of the vehicle.

### EXAMPLE SIX

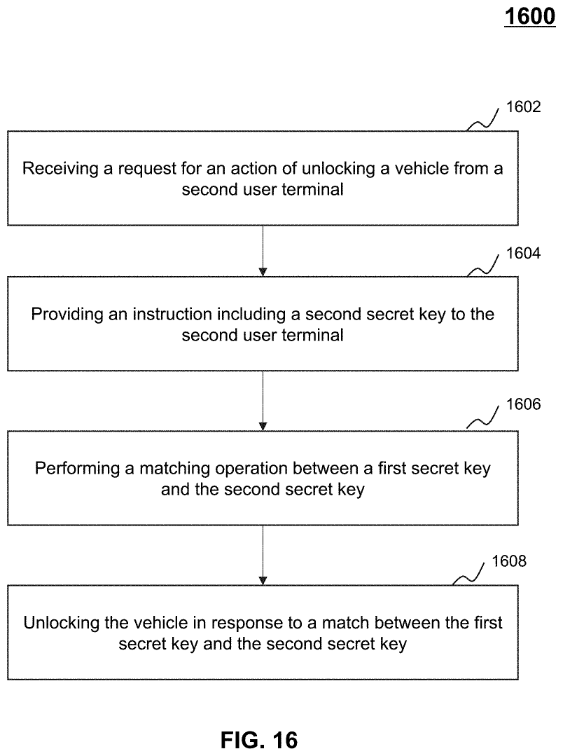

On the basis of the foregoing descriptions of the process 1500 illustrated in FIG. 15, the first secret key included in the secret key reset instruction may be transmitted to the Tbox, and stored in a storage device (e.g., the storage device 430). As used herein, the first secret key may be designated as the target secret key of the Tbox. In certain embodiments, after receiving a second request for unlocking the vehicle from the vehicle management platform, the vehicle management platform may send the second secret key to a second user terminal. Whether or not the vehicle is unlocked depends on a matching between the first secret key stored in the Tbox and the second secret key. FIG. 16 is a flowchart illustrating an exemplary process for unlocking a vehicle according to some embodiments of the present disclosure.

In 1602 of the process 1600, the vehicle management platform (e.g., the first acquisition module 510) may receive a request for an action of unlocking the vehicle from the second user terminal (also referred to herein as the unlock request). The request includes an identifier corresponding to the Tbox of the vehicle to be unlocked.

For example, when the second user desires to unlock the vehicle, the second user transmits the unlock request to the vehicle management platform through the second user terminal. The vehicle management platform receives the unlock request from the second user terminal accordingly.

In some embodiments, before the second user terminal transmits the unlock request to the vehicle management platform, the second user terminal may also transmit a request for checking out the vehicle, a request for opening door, and/or other requests to the vehicle management platform. In some embodiments, the unlock request may be embedded in these requests.

In 1604 of the process 1600, the vehicle management platform (e.g., the first transmitting module 530) may provide an instruction including the second secret key to the second user terminal. Therefore, the vehicle management platform may transmit the second secret key to the second user terminal. The second secret key may be used to unlock the vehicle.

In some embodiments, after receiving the unlock request, the vehicle management platform may obtain the second secret key from the storage device 430, and transmit the second secret key to the second user terminal.

In some embodiments, the vehicle management platform stores the corresponding relation between the identifier of the Tbox and the first secret key and the second secret key. The first secret key and the second secret key may be determined according to a preset rule. For those skilled in the art, the preset rule may be any suitable pairing rule, and not intended to be limiting. For example, the first secret key may be the same as the second secret key. The Tbox may determine whether the second secret key is the same as the first secret key stored in the Tbox, when receiving a verification request from the second user terminal. If the second secret key is the same as the first secret key, which means they are matched successfully. As another example, the second secret key is different the first secret key, but there is a preset relation between the second secret key and the first secret key. The Tbox may determine a result based on the preset relation and the first secret key, and determine whether the result is the same as the second secret key. If the result is the same as the second secret key, which means the second secret key and the first secret key are matched successfully.

In some embodiments, when the second user terminal receives the second secret key, the second user may request a pairing between the second secret key and the first secret key. For example, the second user terminal sends the request to the Tbox, the Tbox may perform a matching operation between the first secret key and the second secret key as illustrated in 1606.

In 1608 of the process 1600, the vehicle may be unlocked in response to a match between the first secret key and the second secret key. If the first secret key matches with the second secret key, the Tbox may unlock the vehicle. After unlocking the vehicle, the second user may be free to use the vehicle.

In some embodiments, if the first secret key does not match with the second secret key, the Tbox may not unlock the vehicle. The vehicle management platform may receive information indicating that the vehicle fails to unlock from the second user terminal. The information may also include the identifier of the Tbox.

For example, the Tbox fails to reset the first secret key as the target secret key or lose data regarding the first secret key after the first user terminal sends the first secret key. Then the target secret key may be an error secret key. When the second user terminal sends the request for pairing the second secret key and the target secret key, the second secret key may not match the error target secret key accordingly. In this case, the second user terminal may transmit the information indicating that the vehicle fails to unlock to the vehicle management platform.

In response to the received information indicating that the vehicle fails to unlock, the vehicle management platform transmits a second instruction for resetting the secret key to the Tbox (also referred to as the second secret key reset instruction). The second secret key reset instruction includes the identifier corresponding to the Tbox. The Tbox may reset the first secret key as the target secret key again in accordance with the second secret key reset instruction. When the reset is successful, the Tbox may send information indicating a successful reset of the target secret key of the Tbox.

After the vehicle management platform receives the failed unlock information from the second user terminal, the vehicle management platform transmits the second secret key reset instruction to the Tbox. The Tbox performs the reset operation in accordance with second secret key reset instruction, and transmit the successful reset information to the vehicle management platform. The second secret key reset instruction includes the first secret key corresponding to the identifier of the Tbox. The Tbox updates the first secret key as the target secret key again.

In some embodiments, the vehicle management platform receives the information indicating the successful reset of the secret key of the Tbox. In response to the information indicating the successful reset of the secret key of the Tbox, the vehicle management platform may generate an instruction for reminding the second user terminal to retry to unlock the vehicle, and transmit the instruction to the second user terminal. The second user terminal may transmit the request for pairing the second secret key and the target secret key (i.e., the first secret key). If the Tbox determines that the first secret key matches with the second secret key, the vehicle management platform may direct the Tbox to unlock the vehicle.

### EXAMPLE SEVEN

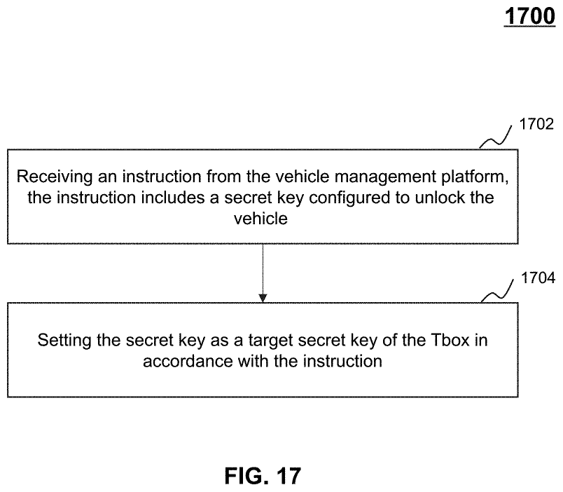

FIG. 17 is a flowchart illustrating an exemplary process for unlocking a vehicle according to some embodiments of the present disclosure. The process 1700 may be implemented on a target control of the item (e.g., the Tbox of the vehicle). In some embodiments, the process 1700 may be stored in the storage device 430 in the form of instructions, and invoked and/or executed by the processor 420.

In 1702, the Tbox (e.g., the second acquisition module 710) may receive a secret key reset instruction from the vehicle management platform. The secret key reset instruction may be used to direct the Tbox to reset its target secret key. For example, the secret key reset instruction prompts the Tbox to reset the first secret key as the target secret key that is used to unlock the vehicle. In some embodiments, the secret key reset instruction includes a first secret key. The first secret key is used to unlock the vehicle.

In 1704, the Tbox (e.g., the second processing module 720) may set the first secret key as the target secret key of the Tbox in accordance with the instruction.

When a first user finishes using the vehicle and desires to return the vehicle, the first user may use the first user terminal to transmit the request for returning the vehicle to the vehicle management platform. Upon receipt of the request for returning the vehicle, the vehicle management platform may generate at least one secret key corresponding to the vehicle. For example, the at least one secret key includes the first secret key and the second secret key. The at least one secret key may be used to unlock the vehicle power. The vehicle management platform may generate the secret key in various ways. The above example is not intended to be limiting.

After generating the at least one secret key, the vehicle management platform may provide the secret key reset instruction including the first secret key to the Tbox. The secret key reset instruction may be used to direct the Tbox to reset the first secret key as its target secret key.

In some embodiments, the corresponding relation between the identifier of the Tbox and the Tbox may be stored in a storage device of the vehicle management platform (e.g., the storage device 113). After the vehicle management platform generates the at least one secret key, the vehicle management platform may retrieve the Tbox corresponding to the identifier included in the request. The vehicle management platform may communicate with the Tbox via the network. The vehicle management platform may transmit the secret key reset instruction to the Tbox. After receiving the secret key reset instruction, the Tbox may reset the received secret key as its new secret key (i.e., the target secret key) in order to replace its old secret key, which may achieve dynamic update of the secret key. When the vehicle is used again, the user needs to use the new secret key to unlock the vehicle, which may improve the safety of the vehicle to avoid illegal use.

In some embodiments, the at least one secret key may include a first Bluetooth pairing code. When a second user desires to check out the vehicle from the vehicle management platform, the vehicle management platform may transmit the first Bluetooth pairing code to the second user terminal of the second user. The second user terminal may request for a Bluetooth pairing between the first Bluetooth pairing code and the Bluetooth pairing code stored in the Tbox. If the pairing is successful, the vehicle is unlocked.

In some embodiments, the at least one secret key may include a second Bluetooth pairing code. When the second user desires to check out the vehicle from the vehicle management platform, the vehicle management platform may transmit the second Bluetooth pairing code to the second user terminal of the second user. The second user terminal may request for a Bluetooth pairing between the second Bluetooth pairing code and the Bluetooth pairing code stored in the Tbox of the vehicle. If the pairing is successful, the vehicle is unlocked.

As described in connection with FIG. 17, when finishing the returning of the vehicle from the first user, the vehicle management platform may generate at least one secret key corresponding to the Tbox of the vehicle. The vehicle management platform may provide the secret key reset instruction to the Tbox. The secret key reset instruction includes the first secret key. The Tbox may reset the first secret key as the target secret key of the Tbox. When the second user desires to check out the vehicle from the vehicle management platform, the second user needs to request for the target secret key of the Tbox in order to unlock the vehicle. The target secret key of the Tbox may be dynamically updated as described in FIG. 17, which may improve the safety of the vehicle. In some cases, the target secret key is always generated by Tbox itself, and keeps unchanged. Once a user obtains the target secret key, the user may use the secret key to unlock the vehicle again and again, which cause a great security risk of the vehicle. Therefore the dynamic updated secret key may improve the safety of the vehicle.

### EXAMPLE EIGHT

On the basis of the foregoing descriptions of the process 1700 illustrated in FIG. 17, the Tbox may receive a request for verifying the second secret key from the second user terminal. For example, the second user terminal sends the request for pairing between the second secret key and the target secret key of the Tbox. In some embodiments, when receives the request for unlocking the vehicle from the second user terminal, the vehicle management platform provides the instruction including the second secret key to the second user terminal. In some embodiments, when the second user terminal receives the second secret key, the second user terminal may send the request for verifying the second secret key to the Tbox. At the same time, the second secret key may be sent to the Tbox for further verification.

In response to the verification request, the Tbox may perform the matching operation between the first secret key and the second secret key. If the first secret key matches with the second secret key, the Tbox may unlock the vehicle.

In some embodiments, if the first secret key does not match the second secret key, the Tbox may not unlock the vehicle. In this case, the Tbox may receive a second secret key reset instruction from the vehicle management platform. The second secret key reset instruction includes the first secret key.

The Tbox may reset the secret key in accordance with the second secret key reset instruction, and transmit the successful reset information to the vehicle management platform. In response to the successful reset information of the secret key of the Tbox, the vehicle management platform may generate an instruction for reminding the second user terminal to retry to unlock the vehicle, and transmit the instruction to the second user terminal.

For example, the Tbox fails to reset the first secret key as the target secret key or lose data regarding the first secret key after the first user terminal sends the first secret key. Then the target secret key may be an error secret key. When the second user terminal sends the request for pairing the second secret key and the target secret key, the second secret key may not match the error target secret key accordingly. In this case, the second user terminal may transmit the information indicating that the vehicle fails to unlock to the vehicle management platform.

In response to the received information indicating that the vehicle fails to unlock, the vehicle management platform transmits a second instruction for resetting the secret key to the Tbox (also referred to as the second secret key reset instruction). The second secret key reset instruction includes the identifier corresponding to the Tbox. The Tbox may reset the first secret key as the target secret key again in accordance with the second secret key reset instruction. When the reset is successful, the Tbox may send information indicating a successful reset of the target secret key of the Tbox.

In some embodiments, when receives the request for returning the vehicle from the first user terminal, the vehicle management platform may provide an instruction for locking the vehicle. The Tbox may receive the locking instruction. In response to the locking instruction, the Tbox may obtain current state data of the vehicle, and determine whether the vehicle currently meets locking conditions based on the current state data. The lock conditions may include but not limited to whether the handbrake is released or not, whether the air conditioning is turned off, whether the vehicle window is closed. If the locking conditions are satisfied, the Tbox may lock the vehicle.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A method for controlling a telematics box (Tbox) of a vehicle connected to a vehicle management platform configured to provide shared use of the vehicle, comprising:
receiving, on the vehicle management platform and from a user terminal, a request for an action of returning the vehicle, the request including an identifier of the Tbox of the vehicle;
generating a first instruction for processing the action of returning the vehicle in response to the request;
providing, from the vehicle management platform, the first instruction to the Tbox of the vehicle;
receiving, on the vehicle management platform, feedback information regarding the vehicle upon completion of the action of the returning the vehicle in accordance with the first instruction; and
generating, based on the feedback information, a second instruction for triggering a mode change of the Tbox from a working mode to a sleeping mode.

2. The method of claim 1, wherein the second instruction further includes a secret key, and the method further comprises:
transmitting, from the vehicle management platform, the secret key to the Tbox of the vehicle.

3. The method of claim 2, further comprising:
receiving, on the vehicle management platform and from a second user terminal, a second request for a second action of checking out the vehicle, the second request including the identifier of the Tbox of the vehicle;
in response to the second request, generating, a third instruction for changing the Tbox from the sleeping mode to the working mode, wherein the third instruction includes a second secret key; and
transmitting, from the vehicle management platform and to the second user terminal, the second secret key.

4. The method of claim 3, further comprising:
performing a matching operation between the secret key and the second secret key; and
triggering the mode change of the Tbox from the sleeping mode to the working mode in response to a match between the secret key and the second secret key.

5. The method of claim 3, wherein the third instruction further includes a message verification code, the method further comprising:
transmitting, from the vehicle management platform, the message verification code directly to the Tbox for triggering the mode change of the Tbox from the sleeping mode to the working mode.

6-11. (canceled)

12. A system for controlling a telematics box (Tbox) of a vehicle connected to a vehicle management platform configured to provide shared use of the vehicle, comprising:
at least one storage device including a set of instructions;
at least one processor in communication with the at least one storage device, wherein executing the set of instructions, the at least one processor is configured to cause the system to:
receive, on the vehicle management platform and from a user terminal, a request for an action of returning the vehicle, the request including an identifier of the Tbox of the vehicle;
generate a first instruction for processing the action of returning the vehicle in response to the request;
provide, from the vehicle management platform, the first instruction to the Tbox of the vehicle;
receive, on the vehicle management platform, feedback information regarding the vehicle upon completion of the action of the returning the vehicle in accordance with the first instruction; and
generate, based on the feedback information, a second instruction for triggering a mode change of the Tbox from a working mode to a sleeping mode.

13. The system of claim 12, wherein the second instruction further includes a secret key, the at least one processor is further configured to cause the system to:
transmit, from the vehicle management platform, the secret key to the Tbox of the vehicle.

14. The system of claim 13, wherein the at least one processor is further configured to cause the system to:
receive, on the vehicle management platform and from a second user terminal, a second request for a second action of checking out the vehicle, the second request including the identifier of the Tbox of the vehicle;
in response to the second request, generate, a third instruction for changing the Tbox from the sleeping mode to the working mode, wherein the third instruction includes a second secret key; and
transmit, from the vehicle management platform and to the second user terminal, the second secret key.

15. The system of claim 14, wherein the at least one processor is further configured to cause the system to:
perform a matching operation between the secret key and the second secret key; and
trigger the mode change of the Tbox from the sleeping mode to the working mode in response to a match between the secret key and the second secret key.

16. The system of claim 14, wherein the third instruction further includes a message verification code, and the at least one processor is further configured to cause the system to:
transmit, from the vehicle management platform, the message verification code directly to the Tbox for triggering the mode change of the Tbox from the sleeping mode to the working mode.

17. (canceled)

18. A system for controlling a telematics box (Tbox) of a vehicle connected to a vehicle management platform configured to provide shared use of the vehicle, comprising:
at least one storage device including a set of instructions;
at least one processor in communication with the at least one storage device, wherein executing the set of instructions, the at least one processor is configured to cause the system to:
receive, on the Tbox, a first instruction for processing an action of returning the vehicle from the vehicle management platform;
perform, on the Tbox, the action of returning of the vehicle in response to the first instruction;
transmit, from the Tbox, feedback information regarding the vehicle to the vehicle management platform upon completion of the action of returning the vehicle; and
receive, on the Tbox and from the vehicle management platform, a second instruction for triggering a mode change of the Tbox from a working mode to a sleeping mode, the second instruction being generated by the vehicle management platform according to the feedback information.

19. The system of claim 18, wherein the second instruction further includes a secret key, the at least one processor is configured to cause the system to:
receive, on the Tbox and from the vehicle management platform, the secret key; and
store, on the Tbox, the secret key in a non-transitory computer readable medium.

20. The system of claim 18, wherein the at least one processor is configured to cause the system to:
receive, on the Tbox and from a second user terminal, a second secret key, wherein the second secret key is part of a third instruction generated by the vehicle management platform when the vehicle management platform receives a request for checking out the vehicle associated with the Tbox, and the second secret key is transmitted from the vehicle management platform to the second user terminal;
perform a matching operation between the secret key and the second secret key; and
trigger a mode change of the Tbox from the sleeping mode to the working mode in response to a match between the secret key and the second secret key.

21. The system of claim 18, wherein the at least one processor is configured to cause the system to:
receive, on the Tbox and from the vehicle management platform, a message verification code;
verify, on the Tbox, the message verification code; and
trigger a mode change of the Tbox from the sleeping mode to the working mode in response to a successful verification.

22. The system of claim 18, wherein the at least one processor is configured to cause the system to:
detect, on the Tbox, a vibration status of the vehicle;
trigger the mode change of the Tbox from the sleeping mode to the working mode based on the detected vibration status of the vehicle.

23. The system of claim 22, wherein the at least one processor is configured to cause the system to:
report, to the vehicle management platform, the detected vibration status of the vehicle.

24-40. (canceled)

41. The system of claim 12, wherein the Tbox is configured to:
receive the first instruction for processing the action of returning the vehicle from the vehicle management platform;
perform the action of returning of the vehicle in response to the first instruction;
transmit the feedback information regarding the vehicle to the vehicle management platform upon completion of the action of returning the vehicle; and
receive, from the vehicle management platform, the second instruction for triggering the mode change of the Tbox from the working mode to the sleeping mode.

42. The system of claim 13, wherein the Tbox is configured to:
receive, from the vehicle management platform, the secret key; and
store the secret key in a non-transitory computer readable medium.

43. The system of claim 18, wherein the vehicle management platform is configured to:
receive, from a user terminal, a request for the action of returning the vehicle, the request including an identifier of the Tbox of the vehicle;
generate the first instruction for processing the action of returning the vehicle in response to the request;
provide the first instruction to the Tbox of the vehicle;
receive the feedback information regarding the vehicle upon completion of the action of the returning the vehicle in accordance with the first instruction; and
generate, based on the feedback information, the second instruction for triggering the mode change of the Tbox from the working mode to the sleeping mode.

44. The system of claim 19, wherein the vehicle management platform is configured to:
transmit, from the vehicle management platform, the secret key to the Tbox of the vehicle.
